(19) United States
(12) Patent Application Publication
(10) Pub. No.: US 2009/0248748 A1
(43) Pub. Date: Oct. 1, 2009

(54) Method and System for Applying Beauty Treatments to an Individual by Generalizing Their Features

(76) Inventor: Bella Shahmoradian, Glendale, CA (US)

Correspondence Address: Cislo & Thomas LLP, 1333 2nd Street, Suite #500, Santa Monica, CA, 90401-4110, US

(21) Appl. No.: 12/416,792

(22) Filed: Apr. 1, 2009

Related U.S. Application Data
(60) Provisional application No. 61/041,507, filed on Apr. 1, 2008.

(51) Int. Cl. G06F 17/30; A45D 44/00

(52) U.S. Cl. 707/104.1; 132/200; 707/E17.044

(57) ABSTRACT

Method, process, and apparatus for beautifying an individual. The method relates to fitting the perfect cut, color, style, makeup and dress to an individual using five pillars based on the outer and inner lines of a person. The first pillar includes determining information about the individual's body shape and head and body proportions. Next, in the second pillar, information is determined about the bone structure of the individual's head. The third pillar includes determining information about the individual's fabric of hair. The fourth pillar includes determining information about the individual's grade of sensitivity. The fifth pillar includes determining information about the individual's face shape. Once the information is gathered about the individual, the stylist can choose the right type of cut, color, style, makeup and dress to administer to the individual. Furthermore, the stylist can prescribe treatment, protection and tools that can be used on the individual's hair.

### REFERENCE TO RELATED APPLICATIONS

This application claims priority to U.S. Provisional Application Ser. No. 61/041,507 titled METHOD OF STYLING HAIR that was filed on Apr. 1, 2008 by Bella Shahmoradian, which is hereby incorporated by reference in its entirety, including, any appendices, screen shots, and references therein.

### FIELD OF THE APPLICATION

The present application relates to cosmetology and more particularly, to a method of providing beautifying treatments to an individual based on their head and body proportions, bone structure of head, fabric of hair, grade of sensitivity of hair, and face shape.

### BACKGROUND

Cosmetology is the study and application of beauty treatments. Included within cosmetology are the branches of cutting, coloring and styling hair. With respect to hair styles, fashion varies from one individual to another and is often based on current trends. These trends are influenced by a number of factors including runway fashion shows, couture, and the music and film industries. Before the 1990's, supermodels were considered to be major fashion icons and the public turned to them for “what's new in fashion.” But after the 1990's, celebrities slowly became fashion icons and designers began marketing and promoting their ideas through them. For example, celebrities such as Brad Pitt, Jennifer Aniston, and Gwyneth Paltrow have become highly recognized fashion icons and have transferred ideas to the public, especially their hair styles.

Generalized hair styles, however, do not always contour to each individual because of an individual's varying characteristics. These characteristics can include their head and body proportions, bone structure of head, fabric of hair, grade of sensitivity of hair, and face shape. These characteristics are often also overlooked when applying other beauty treatments including coloring, cutting, makeup and dress.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with one aspect of the present application, a system for applying treatments to an individual is presented. The system includes a database storing cut, color, style, treatment, protection, and tools information. In addition, the system includes at least one processor and a memory operatively coupled to the processor, the memory storing program instructions. When executed by the processor, the instructions cause the processor to receive information about a head and body proportions of the individual, receive information about a bone structure of a head of the individual, receive information about a fabric of hair of the individual, receive information about a grade of sensitivity of the individual, and receive information about a face shape of the individual. Based on the fabric of hair and grade of sensitivity, the instructions when executed by the processor causes the processor to select and display a prescribed treatment, protection and tools from the database that can be used on the individual's hair. Based on the head and body proportions, bone structure of head, and face shape of the individual, the instructions when executed by the processor causes the processor to select and display a cut, color and style from the database that is most appropriate for the individual's hair.

In accordance with another aspect of the present application, a method for beautifying hair is presented. The method includes in a first pillar, evaluating an individual's head and body proportions. In addition, the method includes in a second pillar, evaluating the individual's bone structure and in a third pillar, evaluating the individual's fabric of hair. Furthermore, the method includes in a fourth pillar, evaluating the individual's grade of sensitivity, and in a fifth pillar, evaluating the individual's face shape. From the pillars, the method includes applying a beautification treatment.

In accordance with yet another aspect of the present application, a process for cutting, coloring and styling an individual's hair is presented. The process includes generalizing the individual's hair to a fabric and grade of sensitivity to select a prescribed treatment, protection and tools to be used on the individual's hair. In addition, the process includes generalizing the individual's head and body proportions, bone structure of head, and face shape to select a hairstyle that can be applied to the individual's hair.

### BRIEF DESCRIPTION OF DRAWINGS

FIG. 1 is an exemplary diagram for beautifying an individual based on five pillars in accordance with one aspect of the application;

FIG. 2 illustrates a normal hair cycle in accordance with one aspect of the application;

FIG. 3 provides further details on pillar one in accordance with one aspect of the application;

FIG. 4 depicts an illustrative “almost perfect” body shape in accordance with one aspect of the application;

FIG. 5 depicts an illustrative “head proportionally larger than the body” body shape in accordance with one aspect of the application;

FIG. 6 depicts an illustrative “head proportionally smaller than the body” body shape in accordance with one aspect of the application;

FIG. 7 diagrams exemplary body types in accordance with one aspect of the present application;

FIG. 8 provides further details on pillar two in accordance with one aspect of the application;

FIG. 9 depicts an illustrative “almost perfect” head shape in accordance with one aspect of the application;

FIG. 10 depicts an illustrative “occipital bone missing” head shape in accordance with one aspect of the application;

FIG. 11 depicts an illustrative “oval head” head shape in accordance with one aspect of the application;

FIG. 12 depicts an illustrative “flat forehead” head shape in accordance with one aspect of the application;

FIG. 13 depicts an illustrative “flat back” head shape in accordance with one aspect of the application;

FIG. 14 shows an exemplary comparison between fabric and hair in accordance with one aspect of the application;

FIG. 15 shows another exemplary comparison between fabric and hair in accordance with one aspect of the application;

FIG. 16 depicts illustrative grades of sensitivity in accordance with one aspect of the application;

FIG. 17 provides exemplary head shapes in accordance with one aspect of the application;

FIG. 18 depicts an exemplary haircut and hair color for “Cristina” based on the five pillars in accordance with one aspect of the application;

FIG. 19 depicts an exemplary haircut and hair color for “Yvette” based on the five pillars in accordance with one aspect of the application;

FIG. 20 depicts an exemplary haircut and hair color for “Kyana” based on the five pillars in accordance with one aspect of the application;

FIG. 21 depicts an exemplary haircut and hair color for “Laurie” based on the five pillars in accordance with one aspect of the application;

FIG. 22 depicts an exemplary hair do and hairstyle for “Hannah” based on the five pillars in accordance with one aspect of the application;

FIG. 23 depicts an exemplary hair do and hairstyle for “Kristy” based on the five pillars in accordance with one aspect of the application;

FIG. 24 depicts an exemplary hair do and hairstyle for “Gohar” based on the five pillars in accordance with one aspect of the application; and

FIG. 25 is a block diagram that shows an exemplary computer architecture used for operating software in accordance with one aspect of the present application.

### DETAILED DESCRIPTION

The detailed description set forth below in connection with the appended drawings and attachments is intended as a description of the present embodiment of the application and is not intended to represent the only forms in which the present application can be constructed or utilized. The description sets forth the functions and the sequence of steps for constructing and operating the application in connection with the illustrated embodiments. However, it is to be understood that the same or equivalent functions and sequences can be accomplished by different embodiments that are also intended to be encompassed with the spirit and scope of the application.

Objects are typically associated with an outer line, which refers to the shape of the object, and an inner line, which refers to the space of the object. When applied to hair, a person can have an outer line that includes curly hair with an inner line that includes the color of red. As an example of the inner/outer line concept, a red ball can have an outer line of a sphere with an inner line of red. Often characteristics of the outer line refer to the shape or silhouette of the hair. These characteristics can include (1) the neck and body shape and whether they are in proportion with the head, (2) the bone structure of the head and whether it is in proportion with the body and neck, (3) when the hair is longer, the shape or outer line of the hair and whether they are in proportion with the body, and (4) the face shape or outer line of the face and whether they are proportional with the neck, body, and head shape. Inner line characteristics refer to skin, color, etc. and will become more apparent as described below.

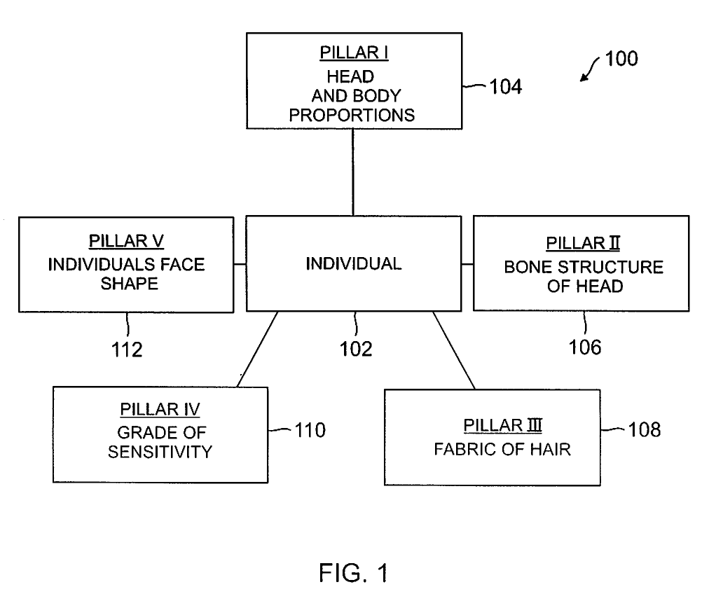

Based on the outer and inner lines of a person, a stylist can create a hair style for each individual. Generally described, the present application relates to cosmetology. More specifically, the present application relates to a system and method for fitting the perfect cut, color, style, makeup, and dress to an individual using five pillars based on the outer and inner lines of a person. In one illustrative embodiment provided in FIG. 1, the first pillar 104 in the method 100 includes a stylist determining information about the individual's 102 head and body proportions. Next, in the second pillar 106, the stylist determines information about the bone structure of the individual's 102 head. The third pillar 108 includes the stylist determining information about the individual's 102 fabric of hair. The fourth pillar 110 includes the stylist determining information about the individual's 102 grade of sensitivity. The fifth pillar 112 includes the stylist determining information about the individual's 102 face shape. Once the information is gathered about the individual 102, the stylist can choose the right type of cut, color, style, makeup, and dress to administer to the individual 102. Further, the stylist can prescribe treatment, protection and tools that can be used on the individual's 102 hair. Generally, the method 100 is designed to minimize or enhance features of the individual 102. A further goal of the method 100 is to create the illusion that the individual 102 has the ideal bone structure and the ideal hair fabric.

The primary importance of the pillars 104, 106, 108, 110, and 112 is to understand how to minimize or emphasize head structure. For example, a person 102 having a small skull structure would need to have thick hair to fill out the missing areas, or curly hair to enhance the missing bone structure. In this example, a stylist would use volumizing products on fine hair and possibly add extensions to create a fuller effect. When a stylist designs a hair style, they try to create the illusion that each client 102 has the ideal bone structure and the ideal hair fabric.

One skilled in the art will appreciate that each pillar 104, 106, 108, 110, and 112 is separate and distinct. Furthermore, each pillar 104, 106, 108, 110, and 112 is not required and any combination of the pillars 104, 106, 108, 110, and 112 can be taken to administer the right hairstyle to an individual. Also, one skilled in the art will appreciate that additional inquiries can be added to customize the disclosed application to the individual 102.

In the present application, the pillars 104, 106, 108, 110, and 112 are applied by a stylist or professional on an individual 102. However, one skilled in the art will appreciate that the pillars 104, 106, 108, 110, and 112 are not limited to a stylist or professional. In another embodiment of the present application, the method 100 can also be used by the individual 102 themselves, a non-professional, or the like. Alternatively, the pillars 104, 106, 108, 110, and 112 can be implemented on a software/hardware interface described below.

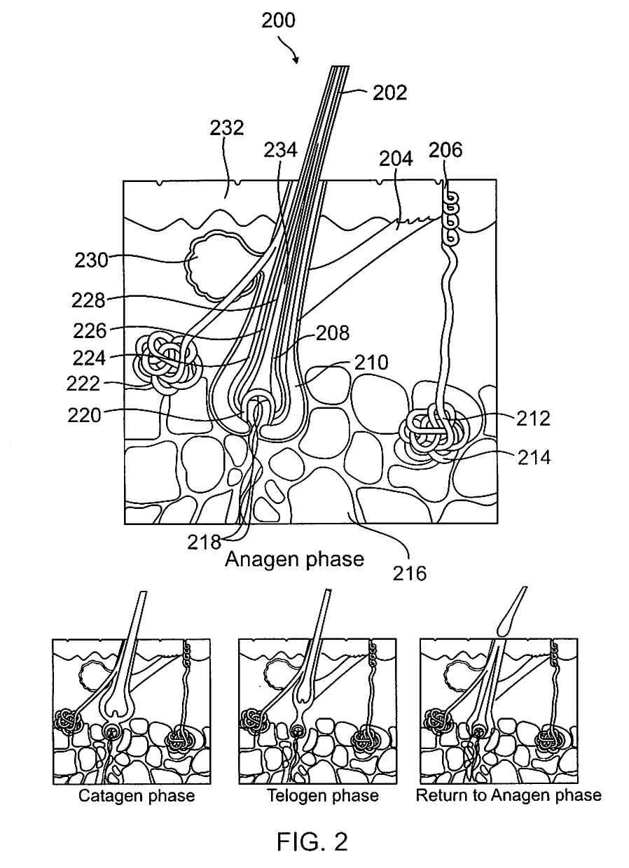

To fully appreciate the method of cosmetology presented herein, the composition of hair is discussed. FIG. 2 is an example of a single hair 200 in accordance with one embodiment of the application. A healthy scalp and hair 200 means that an individual will have a comfortable scalp and beautiful hair 200 from root to end. The root is attached to the blood and nerves 218, typically the reason why plucking or tweezing causes pain. When the hair 200 grows out from the root at the scalp, known as a hair shaft 202, it covers itself with a skin-like layer called the cuticle (KYOO-it-kel) 226. Generally, the cuticle 226 is very delicate. The cuticle 226 protects the inner structure 224 of the hair 200. The cuticle 226 can be composed of a transparent skin overlapping a protective scale i.e. cells that point away from the scalp towards the hair 200 ends. Chemicals raise the scales so that solutions such as chemical relaxers, hair color, or permanents wave solutions can enter the hair cortex 228. Because the hair shaft 202 does not have a nervous system, there is no pain associated with it. Accordingly, no pain is associated with daily aggregations to the hair follicle 202 such as environmental damages (pollution, sun, hard water) and non-healthy lifestyle damages (diet, stress, wrong tools, products). However, without proper care day-to-day the hair shaft 202 becomes weakened or damaged.

The cortex (KOR-teks) 228 is the middle or inner layer giving strength and elasticity to the hair 200. It is made up of a fibrous substance formed by elongated cells. The layer contains the pigment that gives the hair its color. The medulla (mi-DUL-ah) 234 is the innermost layer and is often referred to as the pit or marrow of the hair shaft and is composed of round cells. The medulla 234 can be absent in fine and very fine hair 200. It is present in all wavy and curly hair 200. Generally, the tighter the curl, the stronger the medulla 234.

The follicle 208, bulb 210, and the papilla 220 are the three main structures connected with the hair root. The follicle (FOL-ih-kel) 208 is a tube pocket, in the skin or scalp 232 that covers the hair root. Each hair 200 has its own follicle 208 that varies in depth depending on the thickness and location of the skin. One or more sweat glands 222 are attached to the hair follicle 208. The follicle 208 does not turn straight down into the skin or scalp 232, but is set at an angle. The hair 200 above the surface flows naturally to one side. The bulb 210 is a chunky club-shaped structure that forms the lower part of the hair root and is intended to fit and cover the hair papilla 220. The papilla (pa-PIL-ah) 220 is a small, cone-shaped structure located at the bottom of the hair follicle 208. The papilla 220 fits in to the hair bulb and is rich with blood and nerve 218 supply that contributes to the growth and rebirth of the hair 200. It is through the papilla 220 that nourishment reaches the hair bulb 210. As long as the papilla 220 is healthy and well nourished, it will produce new hair 200 growth.

One skilled in the art will appreciate that there are other structures associated with hair that can affect the beauty of the hair. The arrector pilus (a-rek-tohr-PEYE-leye) is a small automatic muscle that is attached to the bottom of the hair follicles 208. Fear or cold causes it to contact and make the hair stand up straight, giving the skin 232 the appearance of “goose bumps.” The sebaceous (si-BAY-shus) glands 230, or oil glands, consist of little sac-like structures 216 in the skin 232 and are connected to hair follicles 208. Normal secretion of an oily substance from these glands 230, called sebum (SEE-bum), gives luster and pliability to the hair 200 and keeps the skin 232 surface soft and supple. When sebaceous glands 230 become overactive it typically creates oily dandruff and hair loss. The production of sebum can be influenced by diet, blood circulation, emotional disturbances, stimulation of endocrine glands, and drugs.

Sudoriferous (soo-dohr-IF-er-us) 212, or sweat glands, are tube like structures which excrete sweat and consist of a coiled base, or fundus (FUN-dus) 214, and a pipe like duct that terminates at the skin 232 surface to form the sweat pore 206. The sweat glands 212 regulate body temperature and help to eliminate waste products from the body. Sweat glands 212 are typically everywhere. Generally, sweat glands 212 are found more predominately on the palms, soles, forehead, and armpits of the individual. The sweat glands 212 increase their activity by heat, exercise, emotions, and certain drugs. The nervous system controls the excretion of sweat. On average, one to two pints of liquids containing salts are eliminated daily through sweat pores in the skin 232. The hydration of the skin and scalp 232 is produced through the sweat glands 212 and when the skin and scalp 232 are hydrated, the skin 232 is soft and comfortable.

Blood circulation is also an important part of the hair follicle 208. Blood supply delivers nourishment to the hair structure. A healthy diet delivers good nutrition through blood cells to the hair structure. In the absence of a healthy diet, the well being of the hair 200 can be affected.

Emotional stress can also be a sign of unhealthy hair. Endocrine glands are hormones that are released into the blood stream that influences the health of the body and hair 200. General anesthetics and some prescription medications can also affect the health of the hair 200. As an example, hair 200 loss is common after major surgical procedures because of the anesthetics given to the patient.

Typically, hair follicles 208 have a natural defense system that automatically delivers natural moisturizer (through the production of sebaceous 230 and sweat 212 glands). The moisturizer can go up to two inches from the scalp on the hair 200 to protect itself and bring itself to a proper Ph (potential hydrogen) level. Tile proper pH is 4.5 to 5.5 and is essential to prevent excessive dryness and hair 200 damage during the cleansing process. It is vital to stabilize the pH level so that the scalp and hair 200 feels comfortable. The production of the sebaceous 230 and sweat 212 glands will determine the condition of the scalp and the hair 200. Accordingly, the equal production of sebaceous 230 and sweat 212 glands will typically create a normal scalp. The overproduction of sebaceous 230 and underproduction of sweat 212 glands will typically create an oily scalp. The underproduction of sebaceous 230 and sweat 212 glands will typically create a dry scalp. Thus, it is important to have both glands in balance by using the right cleansers that are full of natural ingredients.

The composition of hair 200 mainly includes protein keratin (Ker-ah-tin) and is typically 50.65% carbon, 6.36% hydrogen, 17.14% nitrogen, 5.0% sulfur, and 20.85% oxygen. Human hair 200 is divided into two parts; the root and the shaft. The hair root is located under the skin's surface (scalp) 232 and the hair shaft is that part of the hair structure that extends above the scalps surface.

Hair 200 generally has the same structure and go through a cycle having three phases as depicted in the lower portion of FIG. 2. The three phases are anagen (AN-ah-jen) or growing phase, catagen (CAT-ah-jen) or transitional phase, and telogell (TELL-oh-jen) or resting phase. Normal hair 200 grows and sheds from active to inactive through the three stages and cycles.

During the anagen phrase, healthy hair 200 grows on the scalp. Typically the hair 200 grows about a half inch or (1.25 cm) per month. Generally, 90% of the hair 200 on our head grows at any given time. Each hair 200 grows and lives two to six years and when the hair-shaft diameter increases in size (if not curly) the hair 200 has reached its maximum length. The life cycle of any given hair 200 is determined by gender, age, type of hair, heredity, and nutrition. Accordingly, the rate of human hair 200 growth depends on specific parts of the body, sex, and age. On average, women scalp hair 200 grows faster than men. Scalp hair 200 grows rapidly between the ages of fifteen and thirty and slows down dramatically after age fifty.

The catagen phase is the end of the growth phase. Typically, the phase is short and lasts one to two weeks. During this phase, the lower part of the follicle 208 is destroyed.

At the telogen phase, the catagen phase ends. The hair follicle 208 begins a two to six month phase of resting. During the telogen phase, the follicle 208 is short and rough. Typically, one half to a third of the length of the follicle is active. Only about 10% of our hairs 200 are in the resting phase at any one time.

The hair follicle 208 cycles are not harmonized and each one goes through these three phases independently. After telogen, activity in the hair follicle 208 begins again, returning to the anagen or growing phase. A new hair shaft forms and grows alongside the old hair 200, forcing the old hair to fall out. Everyone looses between forty to one hundred hairs 200 on a daily basis. This is the normal hair cycle.

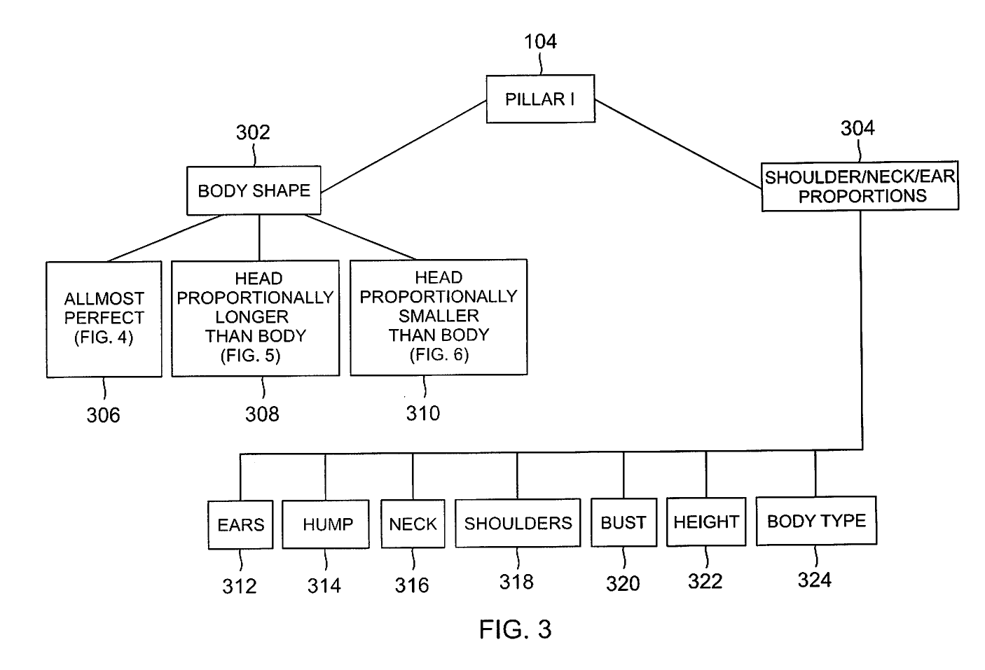

In the present application, the first pillar 104 of the method 100 includes determining information about the body shape 302 and the shoulder/neck/ear proportions 304 of the individual 102 as depicted in FIG. 3. While it is recognized that every individual 102 is unique, these categories are meant to be general, taking into account the fact that body shapes vary from person to person.

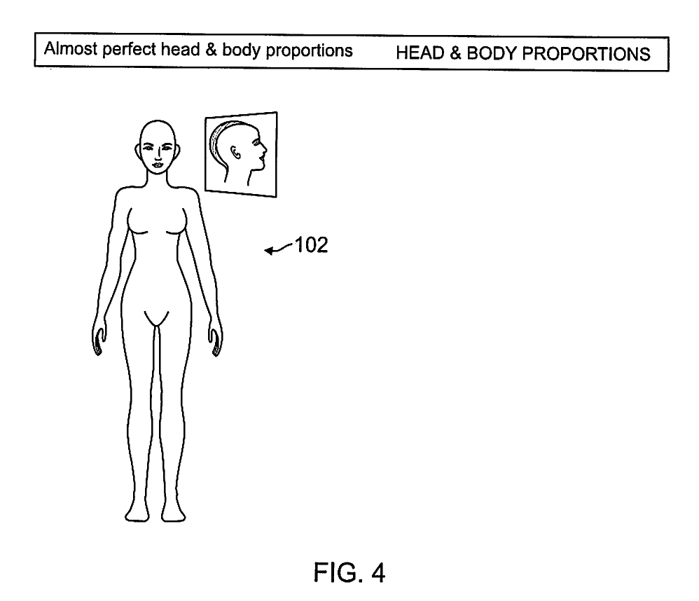

According to one embodiment of the present application, there are three general/basic body shapes 302. The first body type 306 includes an almost perfect proportion between the body and the head of the individual 102 as shown in FIG. 4. Typically, the individual 102 with this body type 306 will be able to find a wide variety of wardrobes, and the individual 102 could easily style their hair. The individual 102 is free to choose any style.

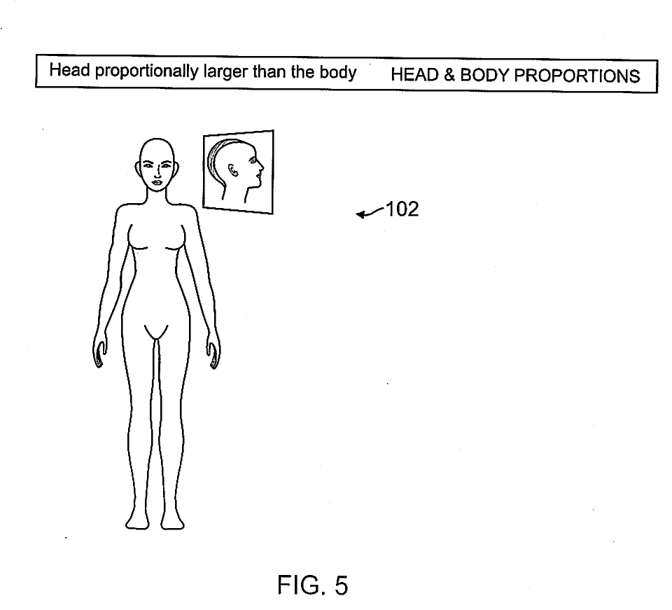

The second body type 308 includes a proportionally larger head compared to that of the body of the individual 102 as shown in FIG. 5. Generally, the individual 102 will have to pay attention to balance the body to the head and head to the body either with a correct wardrobe to make the body appear larger or with an appropriate hair style to make their bead look smaller and slimmer. According to this body type 308, the individual 102 should typically choose a hairstyle with the least volume.

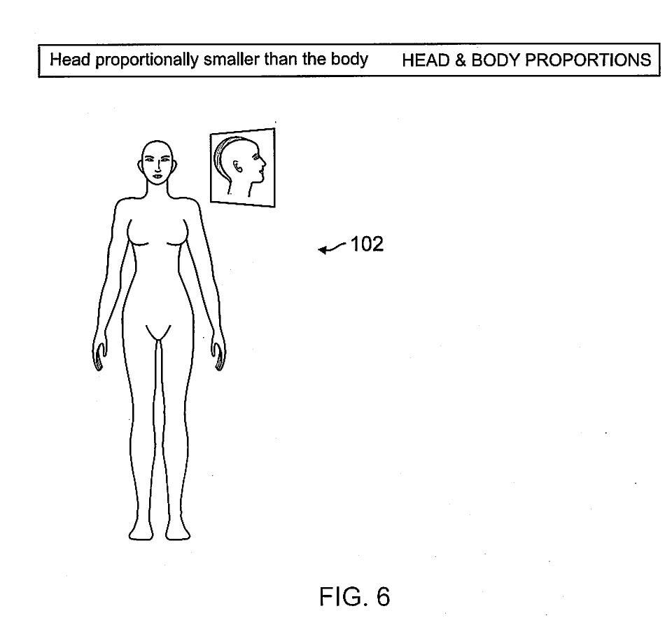

The third body type 310 includes a proportionally smaller head than the body of the individual 102 as shown in FIG. 6. Generally, the individual 102 will have to pay attention to balance the body to the head and the head to the body either with the correct wardrobe to make the body appear smaller and slimmer or with the correct hair styles to make their head look larger and fuller. According to this body type 310, the individual 102 should typically choose a hairstyle with more volume.

The first pillar 104 of the method 100 also includes determining information about the shoulder/neck/ear proportions 304 as depicted in FIG. 3. The shoulder/neck/ear proportions 304 are very important features. The shoulder/neck/ear proportions 304 can be corrected through hair fabric as well as clothing and jewelry. A stylist can use any combination of these techniques to correct disproportion issues.

Determining the right style for an individual's 102 hair using their shoulder/neck/ear proportions 304 typically involves seven inquiries. The first inquiry 312 involves an individual's 102 ears. In order to perform method 100, a stylist covers larger ears with hair. Larger ears that stick out can also be covered with hair. Volume is applied to hair on the sides or back when an individual 102 has small ears that stick out, generally due to side bones in the front and back.

The second inquiry 314 is whether an individual 102 has a hump on their neck. When there is a hump, the individual 102 has to minimize the hump by either covering the hump with an appropriate wardrobe, or by choosing 102 a hairstyle that will cover the hump. Typically, longer hair will cover the hump.

The third inquiry 316 is whether the individual's 102 neck is too long or too short. While the individual 102 can dress or add additional jewelry to emphasize size, keeping the individual's 102 hair long is the best option in both cases.

The fourth inquiry 318 is whether the individual's 102 shoulders are wide or narrow. The individual 102 can dress to compensate for their shoulders. When the individual's 102 shoulders are wide and does not compensate for their shoulders, the stylist can choose a balanced look. For example, the stylist can choose a hairstyle that looks balanced when the hair in the outer line looks in balance with the shoulder size. When the individual's shoulders are narrow and does not compensate for their shoulders, the individual 102 should choose a style that looks balanced by choosing a hair style that gives their hair in the outer line a look that is slightly larger than the shoulder size.

The fifth inquiry 320 is what type of bust line the individual 102 has. Typically, when the individual 102 dresses to minimize or emphasize the bust, the individual need not take further action. When the individual 102 has a large bust and does not dress to minimize, then the individual 102 keeps their hair away from their shoulders and bust. It is important to keep the size of the style proportional or slightly larger than the body. By doing this, the bust will look smaller. When the individual 102 has a small bust and does not dress to emphasize, the individual 102 keeps their hair style on their shoulder so the bust looks larger.

The sixth inquiry 322 is whether individual 102 is short or tall. Generally, when the individual 102 dresses to minimize or emphasize their 102 height, the individual 102 need not take further action. However, when the individual 102 is short and does not dress to maximize their height, the individual 102 will typically have longer straight hair that will emphasize their height. When the individual 102 is tall and does not dress to minimize their height, the individual 102 will typically have longer and slightly fuller hair that will help to minimize their height.

The seventh inquiry 324 is whether the individual 102 is too thin or overweight i.e. what body type the individual 102 has. Generally, when the individual 102 dresses to minimize or emphasize their weight, the individual 102 need not take further action. When the individual 102 is thin and does not dress appropriately, longer and slightly fuller hair will typically help to emphasize body weight. When the individual 102 is overweight and does not dress appropriately, the hairstyle that will typically fit the individual 102 is one that is proportional to the body size. For example, if the head looks smaller compared to the body, then the body looks even more overweight.

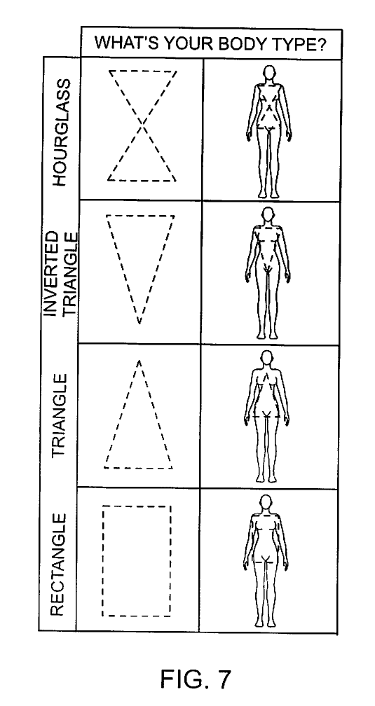

In more detail, FIG. 7 diagrams body types. More specifically, body types can be generalized into four categories including the hour glass, inverted triangle, triangle, and rectangle body type. By determine what body type an individual 102 has, a stylist can determine how to enhance the individuals 102 best body features and minimize flaws.

An individual 102 having an hour glass body type is naturally well proportioned. Typically, an individual with this body type has the same shoulder width as their hips. Generally, their waist is small and defined. For example, Jessica Simpson, Drew Barrymore, Salma Hayek, and Eva Mendes have an hour glass body shape.

An individual 102 having an hour glass body type can wear clothes that outline their shape. The individual 102 should pay attention to their shoulders and hips so that they are in balance while accentuating their hips.

To emphasize their curves, the individual 102, having an hour glass shape, can wear fitted blazers and coats. Typically, they can purchase V-necks, scoop neckline blouses and t-shirts that show off their chest. These individuals 102 can show off their shoulders and add figure hugging dresses, wrap dresses and pencil skirts to their wardrobes. Thin belts around their waist can also provide a way to make their small waist appear even smaller. Well fitted low rise pants draw attention to their shape and accentuate their curves.

Individuals 102 having an invented triangle body shape are often characterized by having broad, square shoulders and narrow hips. For example, Elizabeth Hurley, Nicolette Sheridan, Julia Louis-Dreyfus, and Diane Lane have an inverted triangle body shape.

An individual 102 having an inverted triangle body type can minimize their shoulders and emphasize their bottom to balance out their figure. To emphasize their shape, the individual 102 can wear u-neckline tops and blazers. Typically this will remove attention away from their broad shoulders and minimize their width. These individuals 102 can choose tops and dresses with straps that are close to their neck to minimize their broad shoulders. Generally, full skirts in heavy fabrics, like satin and wool, fill out the bottom half. For extra appeal, the individual 102 can wear a side slit dress to pull attention downwards.

Individuals 102 having a triangle body shape are often characterized by having full hips and bottom. Their shoulders are typically narrow and they have a defined waste. For example, Mischa Barton, Alicia Keys, Kelly Clarkson, and Jennifer Lopez have a triangle body shape.

An individual 102 having a triangle body type can balance their shape by focusing on creating wider shoulders to emphasize their waste and minimize their bottom. To minimize their triangular shape, the individual 102 can typically add structure jackets and blazers to their wardrobe. The strong shoulders generally create a more balanced body. In addition, these individuals 102 can add solids and dark colors below their waste line to minimize their hips and thighs. Strapless dresses and tops, or wide scoop-necks can create the illusion of broadened shoulders and upper body. Also, the individuals 102 should wear stronger textures and fabrics on their upper body. However, they should avoid strong textures and patterns on their lower body.

Individuals 102 having a rectangular body shape are often characterized by having a boyish figure. Their shoulders are almost the same width as their hips, while their waste is not defined. For example, Kate Hudson, Sarah Jessica Parker, Reese Weatherspoon, and Liv Tyler have a rectangular body shape.

An individual 102 having a rectangular body type can try to imitate an hourglass shape by emphasizing their shoulders and playing up their hips. To imitate an hour glass shape, these individuals 102 can play up their shoulders by adding peasant tops and empire dresses to their wardrobe. These can create the illusion of a high waist. In addition, the individual's 102 can show off their bust to distract from their boyish figure. The individuals 102 should look for low-rise pants and skinny jeans because they are usually narrow at the ankles and give shape to their hips. Belts, scarfs, and long necklaces are also a great way to make it appear that they have a defined waste.

While seven inquires for the shoulder/neck/ear proportions 304 have been disclosed, one skilled in the relevant art will appreciate that additional or fewer inquires may be used. Furthermore, these inquires do not have to occur in this specific order, but instead may come in variety of orders and may be repeated.

Returning to FIG. 1, the second pillar 106 of hairstyling method 100 includes determining information about the individual's 102 bone structure in their head. Generally, the stylist will locate the smallest and largest bones located on the individual. The stylist enhances the smallest bones by creating volume. This creates a more balanced effect on their outer line. Alternatively, the stylist minimizes the height and volume on the largest bone. This creates a more balanced effect on their outer line.

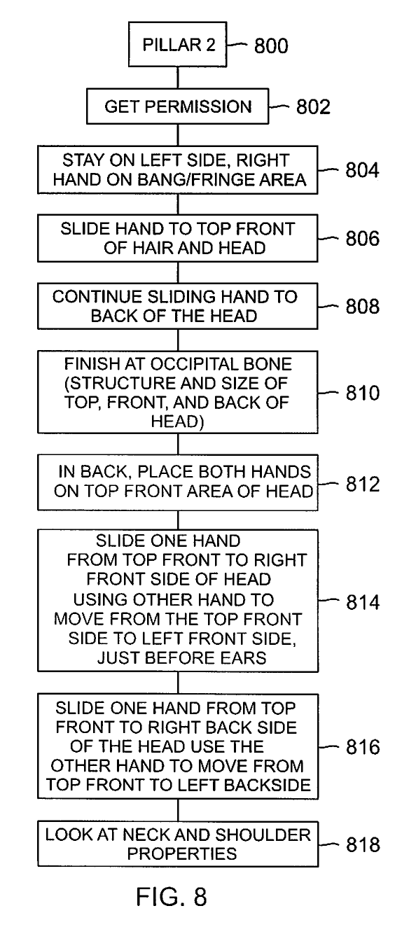

Determining the right style for an individual's 102 hair using their bone structure typically involves nine inquiries as shown in FIG. 8. The first inquiry 802 involves asking permission to touch the individual's 102 head. In this inquiry, the stylist can teach the individual 102 about the stylist's findings.

The second inquiry 804 involves staying on the left side of the client 102 and placing a right hand on the bang/fringe area. Alternatively, the stylist can use their left hand if they are left-handed. The third inquiry 806 involves sliding the hand to the top front portion of the head. The stylist can continue to slide their hand to the back portion of the individual's 102 head in the fourth inquiry 808. The fifth inquiry 810 involves the continuous sliding of the hand to the occipital bone. By this point, the stylist will understand the structure and size of the top, front, and back of the individual's 102 skull and the occipital bone.

The sixth inquiry 812 involves standing in back of the client 102 and placing both hands on the top front area. The seventh inquiry 814 involves sliding one hand from the top front to right front side and using the other hand from the top front side to the left front side of the individual's 102 head just before the ears. By this point, the stylist will have determined the side right and left bone size of individual 102.

The eighth inquiry 816 involves the stylist sliding one hand from the top front to right back side of the head and the other hand from the top front to left back side of the head. This area is in back of the ears. By this point, the stylist will have determined information about the back right and left side bones of the client's 102 head. The ninth inquiry 818 involves the stylist looking at the neck and shoulder proportions of the individual 102.

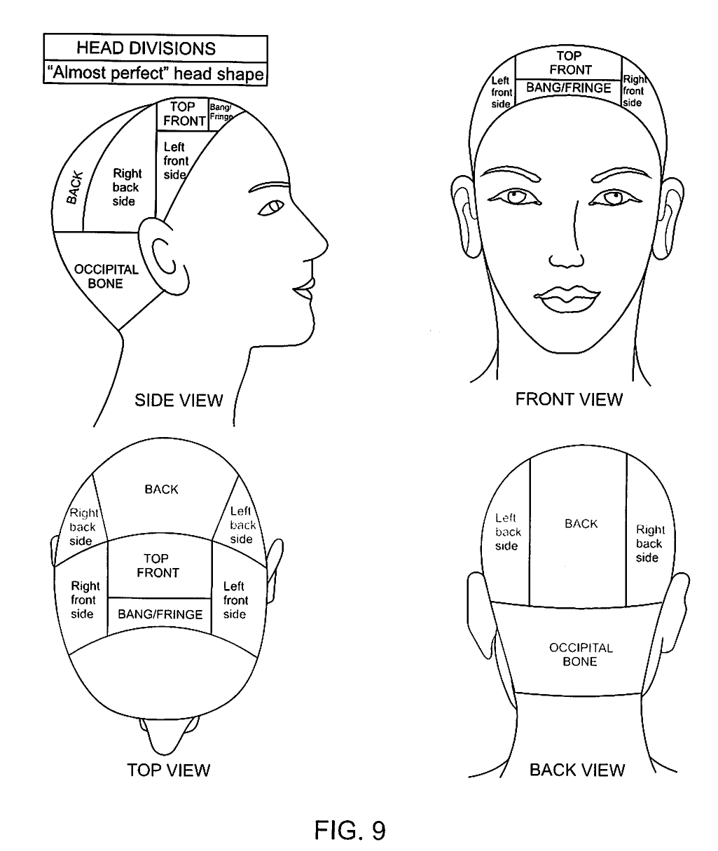

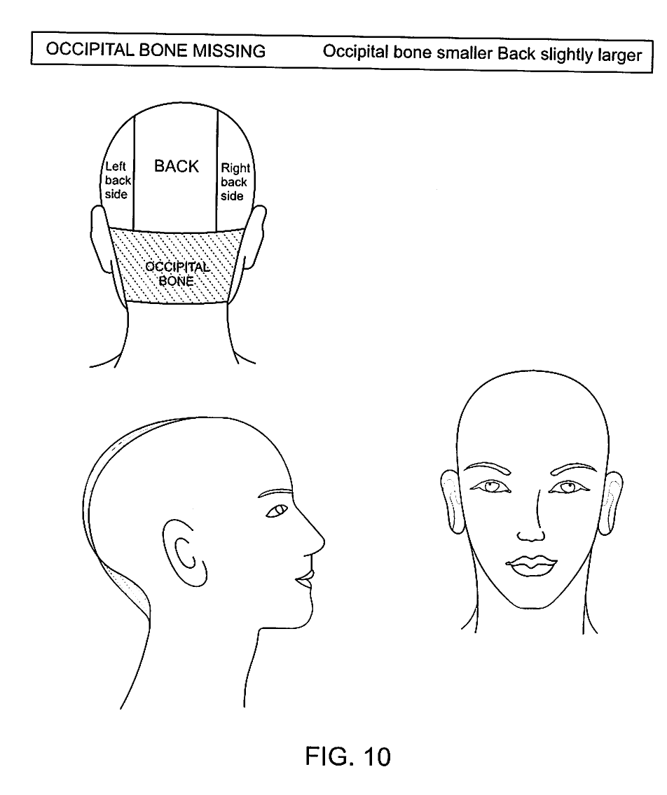

Through these inquiries, a variety of head shapes and bone structures can be determined. FIG. 9 represents an “almost perfect” head shape. An almost perfect head shape does not have any missing bones. With an almost perfect head shape, stylists have great freedom to choose hair cuts and hairstyles. FIG. 10 depicts a head missing the occipital bone. This typically occurs when the backbone and the occipital bone is smaller. A stylist can use cut and style techniques that cover and create fullness in the missing area. For example, blunt cuts or long hairstyles work best. When creating an evening look, a low updo that covers the missing occipital bone works best.

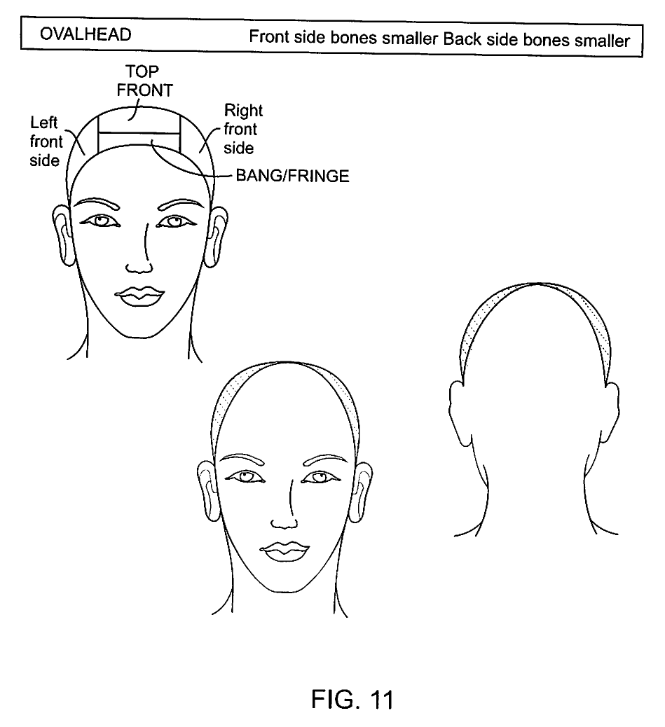

FIG. 11 depicts an oval shaped head. An oval shaped head typically occurs when the front and back side bones are smaller. To overcome the negative aspects of an oval shaped head, the stylist will add volume to these missing areas. Volume can be provided by creating thick or wavy hair, or by employing a volumizing product, back combing, or volume styling.

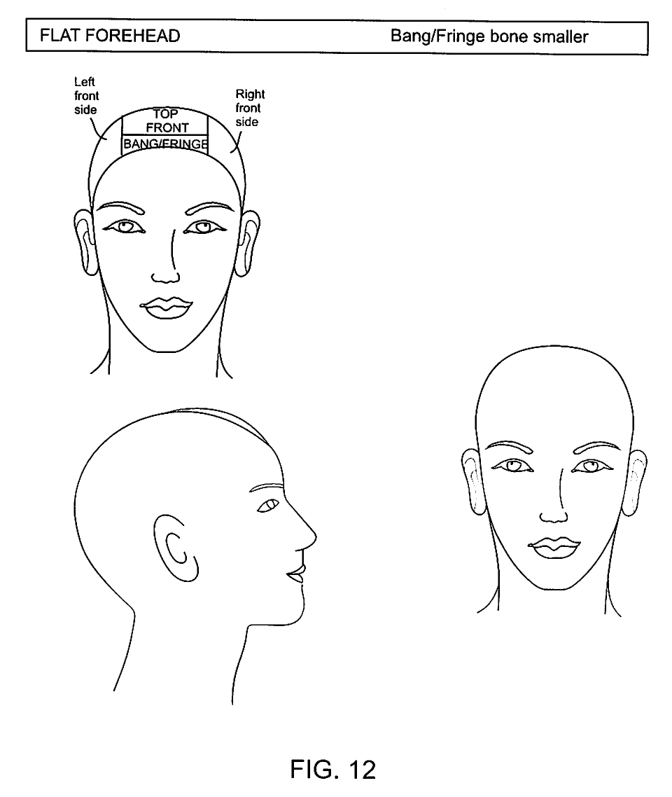

FIG. 12 shows a flat forehead. Cases in which an individual 102 has a wide forehead, the bangs/fringe area is smaller. When an individual 102 has a flat forehead, the stylist will determine if the individual 102 likes to open their forehead or cover it with bangs/fringe. Both methods will work for the individual 102 and both are good tactics to consider when styling the individual's 102 hair.

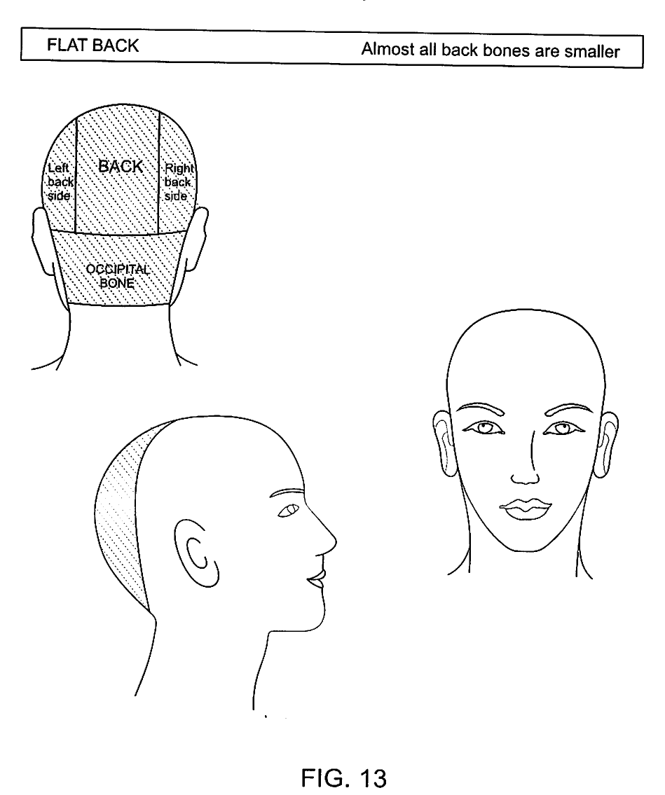

FIG. 13 illustrates an individual 102 with a flat back. A flat back is typically characterized by having backbones that are smaller. A stylist can cover the flat back with a hair fabric that is thick, wavy, or full.

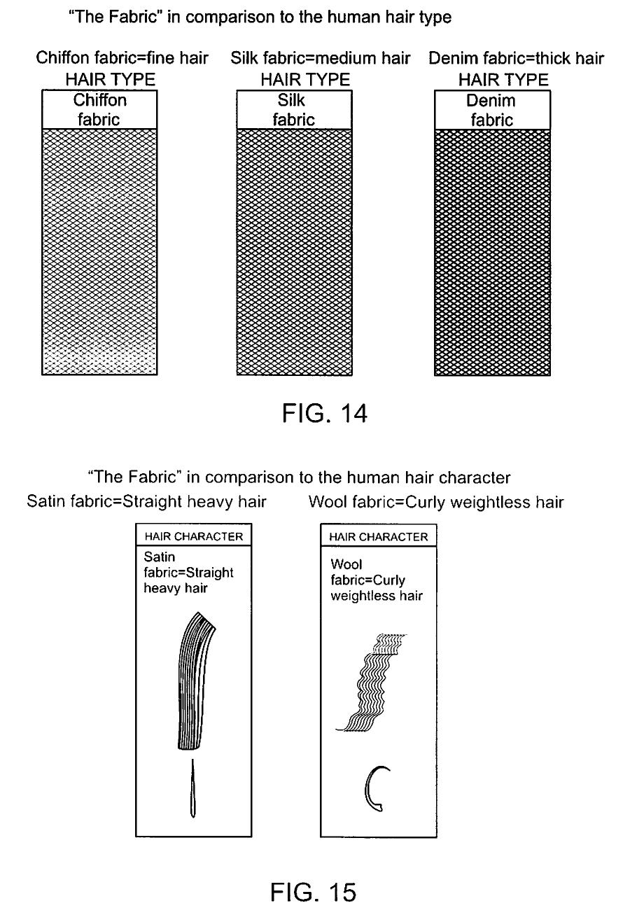

FIG. 14 shows an individual 102 with a brain head. Typically, brain head is characterized by the right front side larger, left front side larger, back larger, right back side larger, left back side larger, occipital bone smaller, and the back of the ears are empty. Normally., the ears stick out, especially when viewed form the back. Since the top of the head is very large, the individual 102 doesn't have volume problems. Nevertheless, a stylist should not do a high updo or cut hair super short. The stylist, in this case, will do a minimal cut keeping the hair long to cover the ear area. The shortest hair should be mid-length covering the neck. The stylist should style keeping the hair long, full, and mostly wavy.

While nine inquiries have been described and presented with respect to the second pillar 106, one skilled in the art will appreciate that there are numerous techniques for determining the bone structure of an individual's 102 head and is not limited the aforementioned discussion.

The third pillar 108 of the hairstyling method 100 includes determining information about the individual's 102 fabric of hair. To determine the fabric of hair and which hairstyling to apply, the stylist takes a thin strip of hair and starts to touch the hair from the root to the ends. Typically, hair qualifies as fine (chiffon fabric), medium (silk fabric), and thick (denim fabric) as shown in FIG. 14. Rarely, is hair classified as ultra fine or ultra thick. Further, there is a fabric between fine and medium and medium and thick. One skilled in the art will appreciate that there are many types of fabric of hair.

To understand the fabric of hair concept, hair can be generally classified in three categories of fabric. The first category is fine hair and is equivalent to chiffon fabric. The hair is characterized by being delicate with a thin diameter, the cuticle layer having one or two layers the occasional absence of no medulla, and the hair loves volumactive products. The second category is medium hair and is equivalent to silk fabric. The hair is characterized by having a normal diameter, tie cuticle layer having three or four layers, and contains medulla. The third category is thick hair and is equivalent to denim fabric. The hair is characterized by being very thick with a visible diameter, the cuticle layer having five or seven layers, contains a thick medulla, and loves softening products.

The hair fabric concept can also be distinguished by straight or curly hair as shown in FIG. 15. Satin fabric can be equivalent to straight heavy hair. It can be characterized as heavy in character. Wool fabric can be equivalent to curly weightless hair. It can be characterized as being weightless, frizzy, born S2 (explained in further detail below), and always contain medulla, even in the fine type.

In some instances, an individual 102 can possess all three types and textures of hair. For example, the hair can be thick in the back, medium on the sides, and tops, and fine in the hairline. At the same time, fifty percent of the hair can be straight and fifty percent curly, which creates very wavy hair.

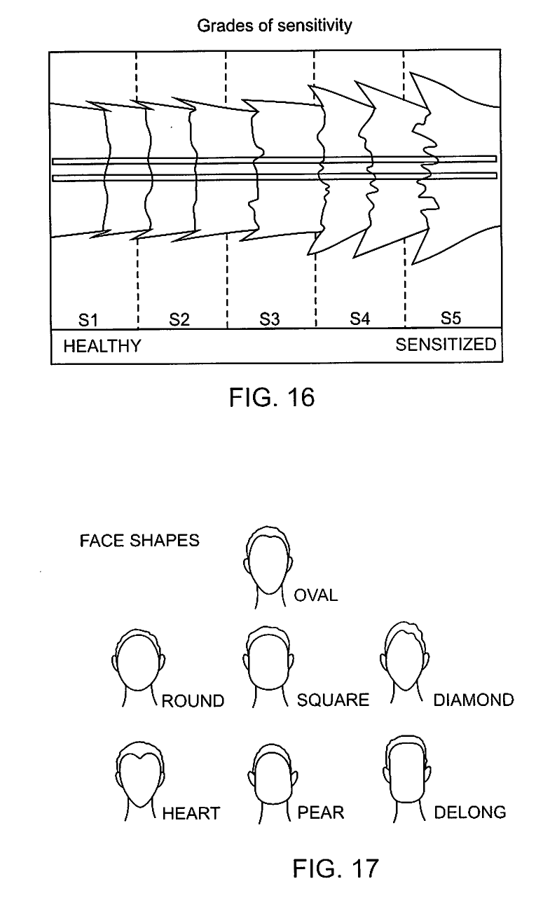

Returning to FIG. 1, the fourth pillar 110 of the hairstyling method 100 includes determining information about the individual's 102 grade of sensitivity of their hair. Generally, there are five levels of sensitivity in the cuticle. The level system to determine the condition of hair and what product the stylist will use can include S1-S2-S3-S4-S5. Each will be described in detail below as illustrated in FIG. 16. One skilled in the art will appreciate that the present application is not limited to a five level system.

Grade S1 indicates healthy hair. Children and adults with short hair are normally in this grade. Hair classified by this grade is characterized by compact tight cuticles, minimal to no chemical treatments or exposure to excessive sun or mechanical styling tools, very little resistance to combing when wet, and feels smooth.

Grade S2 also indicates healthy hair. This is the starting point of curly hair. Hair classified by this grade is characterized by slightly raised cuticles, mild chemical treatments, some environmental exposure, can be up to three levels lighter than natural hair color, and has good elasticity.

Grade S3 indicates the first signs of damaged hair. Hair classified by this grade is characterized by moderately raised cuticles, exposure to chemical treatments and/or regular use of heat improvement, can be up to five levels lighter than natural hair color, resistant to combing without conditioning treatments, fairly elastic, and feels rough.

Grade S4 indicates that the hair is damaged. Hair classified by this grade is characterized by excessively raised cuticles, excessive exposure to chemical treatments and heated styling implements, frizzy appearance when dry, can be up to seven levels lighter than natural color; poor elasticity; re-tangles when combed wet, and feels extremely rough.

Grade S5 indicates hair that is extremely damaged. The hair is breaking apart and needs attention immediately. Hair classified by this grade is characterized by loss of cuticle, exposed to chemical treatments to the point of breakage, hair feels mushy or slimy when wet, can be eight or more levels lighter than natural color, and breaks off when wet.

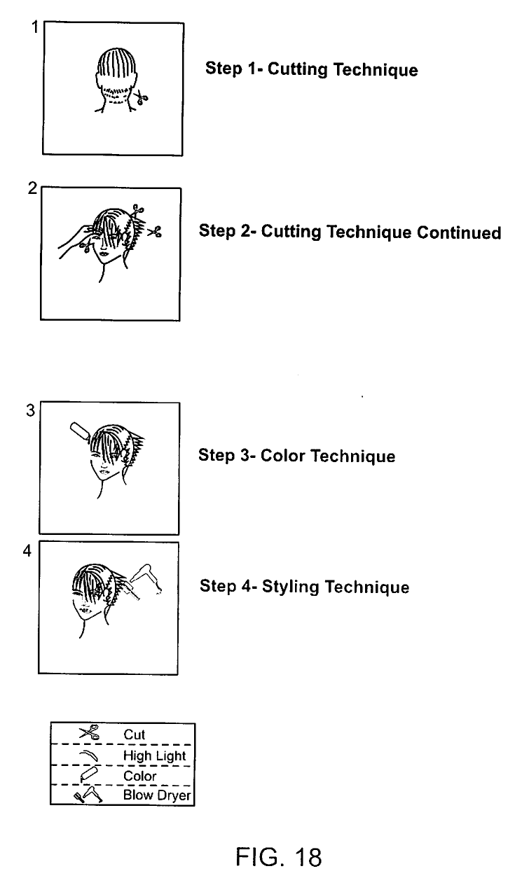

The fifth inquiry 112 of the hairstyling method 100 includes the stylist deterrnining information about the individual's 102 face shape. Facial shape is also an important part of hair design. The bone structure of the face creates facial shapes. There are typically seven facial shapes: oval, round, square, diamond shape, heart shape, pear-shape and oblong. The oval shape is regarded as the ideal shape in American and European cultures. Other cultures consider a more elongated face shape or round shape more appealing. FIG. 17 depicts a variety of face shapes.

Continuing, the stylist creates an illusion that each individual 102 has the ideal face shape. The oval shape can be paced over the other six shapes so that the stylist can see what parts are needed to be enhanced or minimized. Enhancing or minimizing face shape is done in three ways: (1) by hairstyles (refers to the five pillars provided in method 100), (2) by makeup application (during the makeup/makeover process, by shading and highlighting, the stylist can achieve the “almost perfect” oval shape), and (3) by emphasizing beauty points. Eyes and lips are the focal points of the face. By emphasizing these beauty points, the stylist can improve a person's appearance.

One method of determining information about the individual's 102 face is to pay attention to the outer line of the face. Typically, the stylist will stand in front of the client and look directly at the individual's face to see the outer line. The outer lines that the stylist should pay attention to are the individual's 102 chin, jaw line, and hair line. The stylist should then pay attention to the individual's 102 side angle. Again, the stylist should pay attention to the outer line. The outer lines will be the individual's 102 forehead, nose, lips, chin, and neck. When the stylist designs hairstyles, the stylist will be trying to create the illusion that each individual has the ideal oval face shape. The stylist will determine a hair style that enhances or minimizes certain features of the individual's face. The hairstyle can also minimize and enhance the bone structure of the head. Enhancing or minimizing the client's facial shape can also be done by applying makeup. During the makeup process, an “almost perfect” oval shape can be achieved out of any face shape through shading and highlighting.

Returning to FIG. 1, the stylist can choose a cut, color, style, makeup and dress for an individual 102 based on the obtained information from the five pillars of method 100. Furthermore, the stylist can cleanse, treat, and protect the individual's 102 hair. The cleansing step involves shampooing the individual's hair to wash away the dirt. A proper shampoo is chosen according to three elements: scalp conditions, fabric of hair, and bone structures of the head. Because of a natural self defense system, the body starts making its own moisturizer to balance itself to feel comfortable after cleansing. If the hair is over-cleansed with shampoo having harsh ingredients, it will create dryness on the scalp which will cause the overproduction of sebaceous glands to balance the scalp.

Typically, the treatment step can occur by two processes. The masques treatment includes rich penetrating conditioner that nurtures very dry sensitized hair from roots to ends. This restores vitality, shine, and manageability to the individual's hair. The deluxe treatment includes the layering of two treatment masques and adding heat from ten to thirty minutes then rinsing the treatment out. The heat opens the cuticle layers so that the treatments can penetrate deeper to cure the broken cuticle. The treatment step also includes the use of a conditioner. The conditioner is intended to soften, add luster, and make tangled hair easier to comb. Two to five minutes should be used for the conditioner. No heat is needed and the treatment step is followed by a rinse.

The protection step is used to protect the hair from any damage. A layer of foam, cream or oil to cover the scalp and cuticle is used as a shield against environmental abuse such as sun and wind and styling tools such as blow-dryers and irons. A layer of foam such as mousse can be used. Other products that can be used are oil based creams, serum/oil, bio-ionic blow dryer, air dry technique, diffuser, ceramic flat iron, curling iron (for softer curls), thermal brush, and a bore brush.

Although the process has only three steps, one skilled in the art will appreciate that more steps can be performed. The fundamentals for healthy hair are having the right cleansing, treatment, and protection for the individual's hair.

Many different types of scalp conditions exist and the correct selection of shampoo is important. The cleansing shampoo can be chosen according to 50% scalp condition and 50% fabric of hair. One skilled in the art will appreciate that the percentages vary from individual 102 to individual 102. When the scalp is sensitive, contains dandruff, or is experiencing hair loss, the stylist can choose a shampoo according to 100% of the scalp condition in order to comfort the scalp.

For scalps that have become over-sensitized and itchy, the hair style does not matter and the stylist chooses shampoo according to the scalp condition in order to best comfort the scalp. A typical three-step process can be used to cleanse the scalp with a sensitive scalp shampoo. The scalp can be treated to sooth the scalp. The roots can be protected with scalp and root nourishing treatments and stimulators.

For scalps having dandruff, a three step process can be used. Dandruff can either be dry or oily. Dry dandruff is characterized by an itchy scalp and small white scales that are usually attached to the scalp in masses or scattered loosely in the hair. Occasionally they are so profuse that they fall to the shoulders. Dry dandruff is often the result of a sluggish scalp caused by poor circulation, lack of nerve stimulation improper diet, emotional and glandular disturbance, or uncleanliness. Frequency scalp treatments, use of mild shampoos, regular scalp massage, daily use of antiseptic scalp locations, and applications of scalp ointments are all recommended for this disorder. A typical three step process can be used to cleanse the scalp with a sensitive scalp shampoo. The scalp can be treated to sooth the scalp. The roots can be protected with scalp and root nourishing treatments and stimulators.

Oily dandruff is characterized by a scaly condition of the epidermis. The scales become mixed with sebum, causing them to stick to the scalp in patches. There can be itchiness. If the greasy scales are torn off, bleeding or oozing of sebum can follow. A typical three step process can be used to cleanse the scalp with a sensitive scalp shampoo. The scalp can be treated to smooth the scalp. The roots can be protected with scalp and root nourishing treatments and solutions.

For scalps having hair loss a three step process can be used. When the hair and the scalp become weakened, the scalp micro-circulation can be disrupted, which leads to insufficient nutrition to the hair bulb. The bulb is like a small factory that produces the hair fiber. This life source is surrounded by a supple sheath of collagen and is connected to micro-vessels that deliver the nutrients necessary for the growth of thick, dense, and shiny hair. Hair lose usually depends on the excess production of oil and is normal during spring and fall. A typical three step process can be used to cleanse the scalp with a sensitive scalp shampoo. The scalp can be treated to smooth the scalp. The roots can be protected with scalp and root nourishing treatments and solutions.

Generally, the stylist will choose a shampoo also based on the fabric of the hair. For dry/scalp/dry hair conditions, the stylist can choose an extra moisturizing shampoo. For normal scalp/normal hair conditions, the stylist can choose a normal cleansing shampoo. For oily scalp/oily hair, the stylist can choose a deep cleansing and rebalancing shampoo. When the hair cuticle in mid-lengths and ends are in the S3, S4, S5 grades, a wheat protein base shampoo can be used.

When scalps have no condition, typically the stylist will look at the bone structure of the head. If the bone structure of the head is smaller, the stylist can use volumizing to create needed volume. A typical three-step process will be to cleanse with a volumizing shampoo. No treatment will be required for the second step. A volumizing foam will be used to protect the hair.

If the bone structure of the head is larger, the stylist will use moisturizing products to decrease the extra volume. A typical three-step process will be to cleanse with a moisturizing shampoo. No treatment will be required for the second step. To protection the hair, a cream base oil will be used for wool and denim texture of fabric of hair.

Provided below is an exemplary table that can be provided to a stylist in accordance with the present application. The table recommends a prescription to the stylist for the right treatment, protection, and styling tools according to hair type, hair texture, and the grade of sensitivity. One skilled in the art will appreciate that the table is not limiting, but is for illustrative purposes.

| | |
|---|---|
| 1. | Ultra Chiffon/Chiffon |
| Case | The Character - 100% Satin |
| | The Grade of Sensitivity - S1-S2 |
| | Chemically or non-chemically treated hair |
| | Treat - no conditioner needed |
| | Protect - maximum volumizing foam |
| | Tools - Bio Ionic blow-dryer on low heat, use air dry technique |
| | Thermal brush |
| 2. | Ultra Chiffon/Chiffon |
| Case | The Character - 100% Satin |
| | The Grade of Sensitivity - S3-S4-S5 |
| | Chemically or non-chemically treated hair |
| | Treat - wheat protein treatment to repair the cuticle and detangle |
| | Protector - wheat protein cream or sensitized area to make it stronger and |
| | detangle |
| | Tools - Bio Ionic blow-dryer on low heat |
| | Flat iron - cool ceramic iron |
| | Bore brush |
| 3. | Ultra Chiffon/Chiffon |
| Case | The Character - wool/satin |
| | The Grade of Sensitivity - S2-S3 |
| | Chemically or non-chemically treated hair |
| | Treat - wheat protein to repair S's |
| | Protect - cream based oil to soften rough area and heat protection |
| | Tools - blow-dryer, iron |
| | Bore brush |
| 4. | Ultra chiffon/Chiffon |
| Case | The Character - wool/satin |
| | The Grade of Sensitivity - S4-S5 |
| | Chemically or non-chemically treated hair |
| | Treat - wheat protein add oil base cream conditioner to volumize the |
| | treatment, add heat to repair |
| | Protect - cream based oil with extra drop of serum to make the hair |
| | touchable |
| | Tools - blow-dry with medium heat |
| | Flat iron - ceramic preferred |
| | Bore brush |
| 5. | Ultra chiffon/Chiffon |
| Case | The Character - 100% wool |
| | The Grade of Sensitivity - S2-S3 |
| | Chemically or non-chemically treated hair |
| | Treat - protein bases + oil cream/add heat |
| | Protect - cream based + oil |
| | Tools - blow-dry and ceramic flat & curling iron |
| | Bore brush |
| 6. | Ultra chiffon/Chiffon |
| Case | The Character - 100% wool |
| | The Grade of Sensitivity - S4-S5 |
| | Chemically or non-chemically treated hair |
| Prescription | Treat - wheat protein to repair + oil cream masque, need maximum heat |
| | time |
| | Protect - cream + oil |
| | Tools - low heat blow-dryer, use ceramic flat iron or curling iron |
| | Bore brush |
| 7. | Silk |
| Case | The Character - 100% satin |
| | The Grade of Sensitivity - S1-S2 |
| | Chemically or non-chemically treated hair |
| | Treat - no need to condition if hair is extra long, light condition the tips |
| | only |
| | Protect - volumactive foam |
| | Tools - blow-dry use air dry technique |
| | Thermal brush |
| 8. | Silk |
| Case | The Character - 100% satin |
| | The Grade of Sensitivity - S3-S4 |
| | Chemically or non-chemically treated hair |
| P | Treat - treat-wheat protein + heat |
| | Protect - cream base wheat protein to repair |
| | Tools - blow-dry, flat iron, curler |
| | Bore brush and thermal brush |
| 9. | Silk |
| Case | The Character - 100% satin |
| | The Grade of Sensitivity - S5 |
| | Chemically or non-chemically treated hair |
| | Treat - wheat protein + oil heat |
| | Protect - cream base + oil |
| | Tools - low heat ceramic iron |
| | No brush, use wide comb only |
| 10. | Silk |
| Case | The Character - 50% satin, 50% wool |
| | The Grade of Sensitivity - S2 |
| | Chemically or non-chemically treated hair |
| | Treat - moisturizing conditioners, once a week heat treatment masque |
| | Protect - for blow drying cream base oil for blow drying |
| | Protect - for natural curl- curl enhancers leave in treatment |
| | Tools - blow-dry, diffuser, iron |
| | Bore brush and thermal brush |
| 11. | Silk |
| Case | The Character - 50% satin, 50% wool |
| | The Grade of Sensitivity - S3-S4 |
| | Chemically or non-chemically treated hair |
| | Treat - wheat protein + cream masque add heat, until it gets to S2 |
| | Protect - for blow-drying cream base oil |
| | Protect - for natural curl - curl enhancers leave in treatment |
| | Tools - blow-dry diffuser, curler of flat iron |
| | Bore brush |
| 12. | Silk |
| Case | The Character - 50% satin, 50% wool |
| | The Grade of Sensitivity - S5 |
| | Chemically or non-chemically treated hair |
| | Treat - wheat protein + cream masque + heat, every time until it improves |
| | Protect - wheat protein leave in + add drop of serum or oil |
| | Protect - for natural curl - curl enhancers leave in treatment |
| | Tools - blow-dry on cool to dry the hair, use a ceramic iron mostly to style |
| 13. | Silk |
| Case | The Character - 100% wool |
| | The Grade of Sensitivity - S2-S3 |
| | Chemically or non-chemically treated hair |
| | Treat - use masque as conditioner, add heat every time |
| | Tools - blow-dry |
| | Bore brush |
| 14. | Silk |
| Case | The Character - 100% wool |
| | The Grade of Sensitivity - S4-S5 |
| | Chemically or non-chemically treated hair |
| | Treat - wheat protein + deluxe masque + heat until it get better |
| | Protect - leave in wheat protein cream + oil |
| | Protect - for natural curls - cream curls enhancer |
| | Tools - blow-dry, diffuser for curl, ceramic iron preferable |
| | Bore brush |
| 15. | denim |
| Case | The Character - 100% satin |
| | The Grade of Sensitivity - S1-S2 |
| | Chemically or non-chemically treated Hair |
| | Treat - cream conditioner, heat masque weekly |
| | Protect - cream base product |
| | Tools - blow-dry, flat iron, curling iron |
| | Thermal brush - yes |
| | Bore brush and thermal Brush |
| 16. | Denim |
| Case | The Character - 100% satin |
| | The Grade of Sensitivity - S3-S4 |
| | Chemically or non-chemically treated hair |
| | Treat - wheat protein + oil base cream masque + heat |
| | Protect - what protein leave in + oil base cream |
| | Tools - blow-dry, flat iron and curlers |
| | Bore brush |
| 17. | Denim |
| Case | The Character - satin |
| | The Grade of Sensitivity - S5 |
| | Chemically or non-chemically treated hair |
| Prescription | Treat - wheat protein + oil masque + heat, every time until it improves |
| | Protect - wheat protein leave in + oil treatment |
| | Tools - flat iron |
| | No brush only wide comb |
| 18. | Denim |
| Case | The Character - 50% satin, 50% wool |
| | The Grade of Sensitivity - S2-S3 |
| | Chemically or non-chemically treated hair |
| | Treat - wheat protein, deluxe oil base treatment, oil cream + masque |
| | Protect - oil + serum |
| | Protect - for natural curls - cream curls enhancer |
| | Tools - blow-dry, flat or curling iron, diffuser for curl |
| | Bore brush |
| 19. | Denim |
| Case | The Character - 50% satin, 50% wool |
| | The Grade of Sensitivity - S4-S5 |
| | Chemically or non-chemically treated hair |
| | Treat - deluxe oil base treatment, oil cream + masque add heat until it |
| | improves |
| | Protect - leave in wheat protein, layer with oil serum |
| | Protect - for natural curls - cream curls enhancer add oil |
| | Tools - low heat blow-dry, ceramic flat iron, diffuser |
| | No brush, wide combo |
| 20. | Denim |
| Case | The Character - 100% wool |
| | The Grade of Sensitivity - S2-S3 |
| | Chemically or non-chemically treated hair |
| | Treat - maximum oil base masque + cream base masque, heat every time |
| | Protect - maximum oil + serum |
| | Protect - for natural curls - cream curls enhancer add oil |
| | Tools - ceramic flat iron, diffuser, wrap twist technique (coil look) |
| | Bore brush |
| 21. | Denim |
| Case | The Character - 100% wool |
| | The Grade of Sensitivity - S4-S5 |
| | Chemically or non-chemically treated hair |
| Prescription | Treat - wheat protein + oil base mask, add heat until it improves |
| | Protect - wheat protein leave in treatment + maximum oil + serum |
| | Protect - for natural curls - cream curls enhancer add oil |
| | Tools - no heat preferable wrap twist technique (coil look) plus diffuser or |
| | flat iron |
| | Bore brush |
| | *When the fabric of the hair is ultra denim, 50 percent wool or above and |
| | the grade of sensitivity is S3-S4-S5, it is hard to manage. In such cases, |
| | the individual 102 needs an expert hair dresser. |
| 21. | Fabric of the hair: Chiffon/fine silk/medium denim/thick |
| Case | Character: Combination satin/straight wool/curly |
| Prescription | Pre-Treat: wet hair with clean water and apply a conditioner |
| | Treat - wheat protein plus oil base masque, add heat until it improves |
| | Protector - wheat protein leave-in treatment layer with serums |
| | Tools - according to the hair fabric and chosen style |

Thus, the hairstyling method 100 includes five pillars. From the pillars, a stylist can select an appropriate hair style based on the head and body proportions, bone structure, and face shape of the individual 102. Further, the stylist can prescribe treatment, protection and tools that can be used on the individual's 102 hair based on the fabric of hair and grade of sensitivity.

A set of examples now detail the hairstyling method 100.

Christina

| | |
|---|---|
| Pillar 1 | Body Shape and Head and Body Proportions |
| | Almost perfect body and head proportion |
| Pillar 2 | Bone Structure/Head Divisions |
| | Oval head, front and back side bones are smaller |
| Pillar 3 | The Fabric of the Hair |
| | Hair Type: Chiffon/Fine hair |
| | Hair Character: 100 percent satin/straight |
| Pillar 4 | Grade of Sensitivity |
| | S1; Virgin Hair |
| | Natural Hair Color: Medium Brown |
| | Chemically Treated hair: No |
| | Target Color Process: Medium ash-brown for her base. This color |
| | enhances the olive skin tone. Medium cameral tone for highlighting to |
| | bring out her pretty brown eyes |
| Pillar 5 | Face Shape |
| | Oval Face |
| | Composition of the Hair |
| | Healthy Scalp |
| | Cleanse/Treat/Protect |
| | Shampoo: Volumizing Shampoo |
| | Prescription: Treat (no conditioner needed) |
| | Protect: Maximize volumizing foam |
| | Tools: Bio-ionic blow dryer on low heat; use air-dry technique |
| | Flat iron: no |
| | Thermal Brush: Yes |
| Hair Style | FIG. 18 |
| | Step 1 - Cutting Technique |
| | Start design line in the back. Head should be titled forward. Use a razor or |
| | point cut to create a shattered design line along the natural hair line. While |
| | tilting head slightly towards you, take 1 inch horizontal sections and |
| | continue to razor or point cut to the apex. The hair should be elevated to |
| | create movement and graduated effect. |
| | Step 2 - Cutting Technique Continued |
| | Create a design line around the ear, connecting the back to the front. Take |
| | 1-inch diagonal sections and continue this pattern towards the apex, |
| | maintaining low graduation on the top section. Repeat on opposite side. |
| | Moving to the fringe, keep head tilted towards you; by razor or point cue |
| | create a slanted fringe started below the eyebrows on the left side |
| | connecting to the right side on the cheek bone. Keep the head to the |
| | upright position; create the designer look on the sides to connect the fringe |
| | area to side sections by point cutting. Dry cut the hair to define and |
| | personalize and slice cut each section to add movement and texture to the |
| | hair cut. |
| | Step 3 - Color Technique: Mix |
| | A medium ash brown deposit only color for her base. Apply scalp to the |
| | ends. On the fringe area, use the block technique to create medium |
| | caramel highlights. Process the color for 20 minutes under heat. |
| | Step 4 - Styling Technique |
| | Blow dry hair completely using a large amount of volumizing foam on root |
| | to the ends. Finish with the flat iron to emphasize the texture on the ends. |

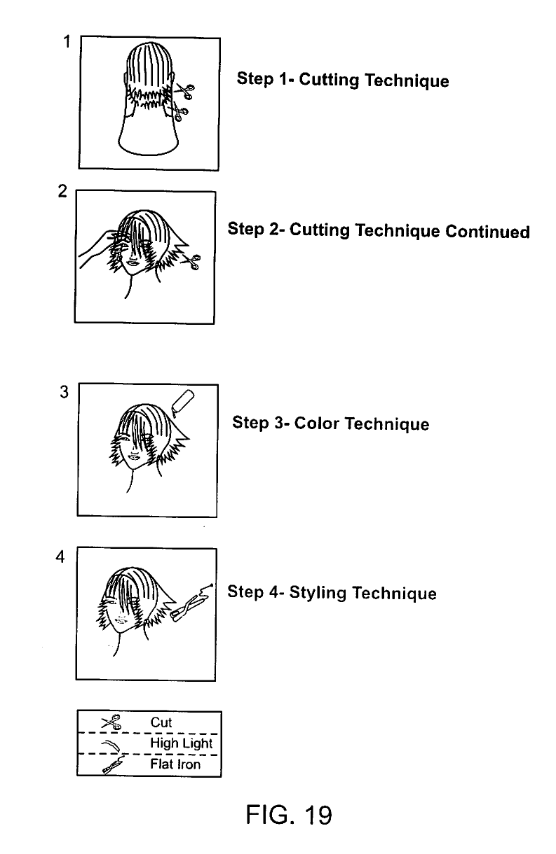

Yvette

| | |
|---|---|
| Pillar 1 | Body Shape and Head and Body Proportions |
| | Almost perfect body and head proportion |
| Pillar 2 | Bone Structure/Head Divisions |
| | Flat back. Almost all backbones are smaller |
| Pillar 3 | The Fabric of the Hair |
| | Hair Type: silk/medium hair |
| | Hair Character: 50 percent satin/straight and 50 percent wool/curly |
| Pillar 4 | Grade of Sensitivity |
| | Roots S1; ends S4. After cut and color treatment the entire hair is restored |
| | to an S2 |
| | Natural Hair Color: Dark Brown |
| | Chemically Treated hair: Yes, the color-treated hair was medium brown |
| | Target Color Process: Warm chocolate brown |
| Pillar 5 | Face Shape |
| | Oval Face |
| | Composition of the Hair |
| | Very Healthy Scalp |
| | Cleanse/Treat/Protect |
| | Shampoo: A light moisturizing shampoo for color-treated hair |
| | Treat: Moisturizing conditioners; once-a-week heat treatment masque |
| | Protect: Cream-base oil for blow drying |
| | Protect(s): (For natural curl) curl enhancers, leave-in treatment |
| | Tools: Blow-dryer, diffuser, flat iron, bore brush, thermal brush |
| Hair Style | FIG. 19 |
| | Step 1 - Cutting Technique |
| | Start design line in the back. Use a razor or point cut to create a shattered |
| | design line 1 inch below the hairline in the nape. |
| | Step 2 - Cutting Technique Continued |
| | Connect sides to the design line created in the back by taking diagonal |
| | partings. Continue to take 1 inch partings while moving towards the apex. |
| | The design line that connects the sides to the back should fall just below |
| | the jaw line. Repeat on opposite side. Moving to the fringe, keep head to |
| | the upright position; create a straight fringe below the eyebrows. Tilt head |
| | slightly towards you to connect the fringe area to side sections. Point cut |
| | each section to add movement and texture to the hair cut. |
| | Step 3 - Color Technique |
| | Mix a warm chocolate brown color. Apply scalp to the ends. Process the |
| | color for 20 minutes. |
| | Step 4 - Styling Technique |
| | Blow dry hair completely using a small amount of volumizing foam on |
| | root cream base oil on ends. Finish with the flat iron to emphasize the |
| | texture of the ends. |

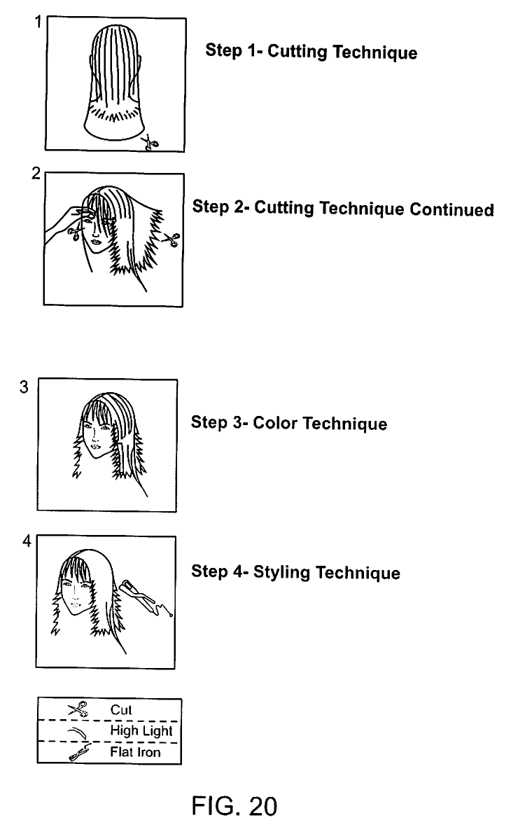

Kyana

| | |
|---|---|
| Pillar 1 | Body Shape and Head and Body Proportions |
| | Almost perfect body and head proportion |
| Pillar 2 | Bone Structure/Head Divisions |
| | Oval head, front and back side bones are smaller |
| Pillar 3 | The Fabric of the Hair |
| | Hair Type: denim/thick hair |
| | Hair Character: 100 percent wool/curly |
| Pillar 4 | Grade of Sensitivity |
| | Roots S2; ends S4-S5. After color and cut treatment, entire hair is restored |
| | to an S3 |
| | Natural Hair Color: Dark Brown |
| | Chemically Treated hair: Yes. |
| | Target Color Process: Eggplant for the base; vibrant red for the highlights |
| Pillar 5 | Face Shape |
| | Oval Face with strong jaw line |
| | Composition of the Hair |
| | Very Healthy Scalp |
| | Cleanse/Treat/Protect |
| | Shampoo: Swimmer's shampoo and a red color-depositing shampoo |
| | For active swimmers: re-treat; wet hair with clean water and apply |
| | conditioner |
| | Note: there are products on the market created for this case. |
| | Treat: wheat protein plus oil-base masque; add heat until it improves |
| | Protector: what protein leave-in treatment plus maximum oil plus serum |
| | Protector for natural curls: cream curl enhancer; add oil |
| | Tools: choose style according to their hair fabric. |
| Hair Style | FIG. 20 |
| | Step 1 - Cutting Technique |
| | Start design line in the back. Use a razor or point cue to create a design |
| | line below the collar bone. Use 1-inch horizontal sections, slightly |
| | elevating each section as you cut to create low graduation. Continue to |
| | apex of the head. |
| | Step 2 - Cutting Technique Continued |
| | In the front, take vertical sections from the center part to the ear. Start at |
| | the bang to create the design line. As you move from the bang to the ear, |
| | connect this section with the back sections. Continue this pattern to the |
| | apex. Repeat on the opposite side. Create a disconnected fringe area. |
| | Moving to the fringe, keep head to the upright position; create a straight |
| | fringe below the eyebrows. To personalize the design, after blow drying |
| | and flat ironing the hair by using shears, point cut the outer layers of the |
| | haircut to create softness and texture. |
| | Step 3 - Color Technique |
| | Mix an eggplant deposit only for base color. Use vibrant red plus 40 |
| | volume for highlights, process 20 minutes under heat followed by funky |
| | vampire red for 15 minutes as a glazing toner. |
| | Step 4 - Styling Technique |
| | Blow dry hair completely using wheat protein leave in treatment plus |
| | maximum oil serum on ends. Finish with the flat iron to emphasize the |
| | texture on the ends. |

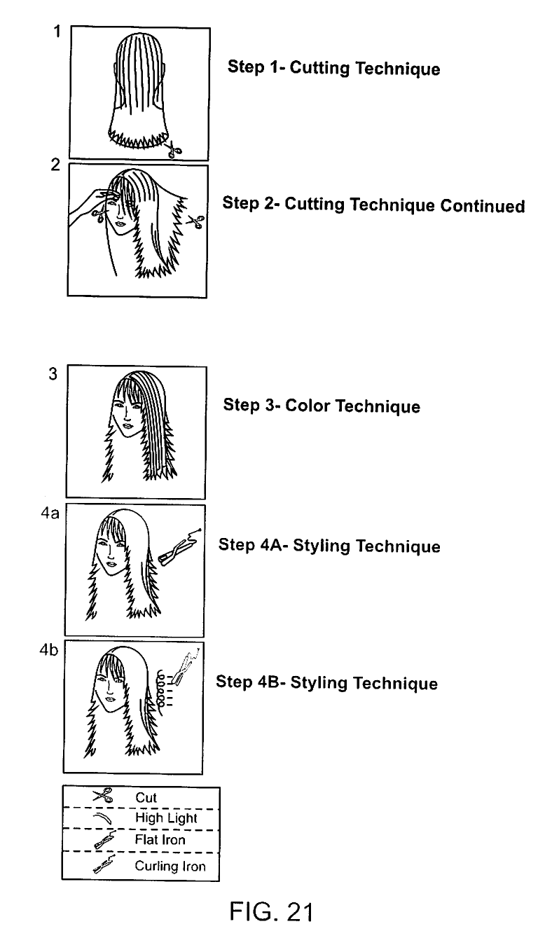

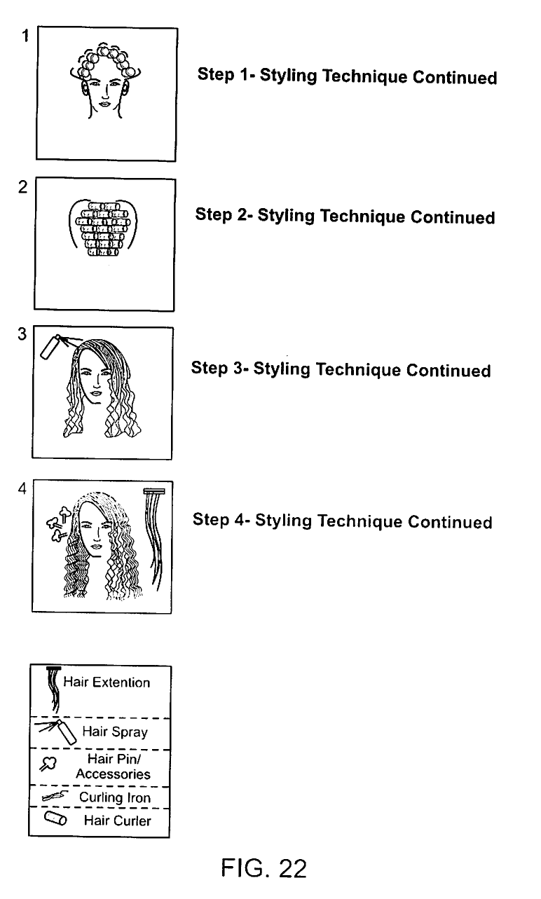

Laurie

| | |
|---|---|
| Pillar 1 | Body Shape and Head and Body Proportions |
| | Almost perfect body and head proportion |
| Pillar 2 | Bone Structure/Head Divisions |
| | Flat forehead; bang and fringe bone smaller |
| Pillar 3 | The Fabric of the Hair |
| | Hair Type: silk/medium hair |
| | Hair Character: 50 percent satin/straight; 50 percent wool/curly |
| Pillar 4 | Grade of Sensitivity |
| | Root S2; ends S3-S4. After color and cut treatment, entire hair is restored |
| | to an S2 |
| | Natural Hair Color: Dark Brown |
| | Chemically Treated hair: Yes. Color-treated hair was dark brown with |
| | light brown highlights |
| | Target Color Process: At the base, light coppery brown and strawberry |
| | blonde highlights |
| Pillar 5 | Face Shape |
| | Very thin oval face |
| | Composition of the Hair |
| | Healthy Scalp |
| | Cleanse/Treat/Protect |
| | Shampoo: Light moisturizing shampoo for color-treated hair |
| | Treatment: Moisturizing conditioners; once-a-week heat treatment masque |
| | Protector for blow dryer: cream-based oil |
| | Protector for natural curl: curl enhancers; leave-in treatment |
| | Too: blow dryer; diffuser, iron |
| | Brush: bore brush, thermal brush |
| Hair Style | FIG. 21 |
| | Step 1 - Cutting Technique |
| | Start design line in the back. Use a razor or point cut to create a design |
| | line below the shoulders. Use 1-inch horizontal sections, slightly elevating |
| | each section as you cut to create low graduation. Continue to apex of the |
| | head. |
| | Step 2 - Cutting Technique Continued |
| | In the front, take vertical sections from the center part to the ear. Start at |
| | the bang to create the design line. As you move from the bang to the ear, |
| | connect this section with the back sections. Continue this pattern to the |
| | apex. Repeat on the opposite side. Create a disconnected fringe area. |
| | Moving to the fringe, keep head to the upright position; create a straight |
| | fringe below the eyebrows. To personalize the design, after blow drying |
| | and flat ironing the hair by using shears, point cut the outer layers of the |
| | haircut to create softness and texture. |
| | Step 3 - Color Technique |
| | Mix a medium coppery brown for base color. Use 30 volume bleach for |
| | highlights, process 20 minutes under heat followed by coppery strawberry |
| | blonde toner for 5 minutes. |
| | Step 4A - Styling Technique |
| | Blow dry hair completely using a small amount of volumizing foam on |
| | root and cream base oil on ends. Finish with the flat iron to emphasize the |
| | texture on the ends. For alternative look, use large curling iron. Create |
| | large curls from mid to the ends. |
| | Step 4B - Styling Technique |
| | For alternative look, use large curling iron. Create large curls from mid to |
| | the ends. |

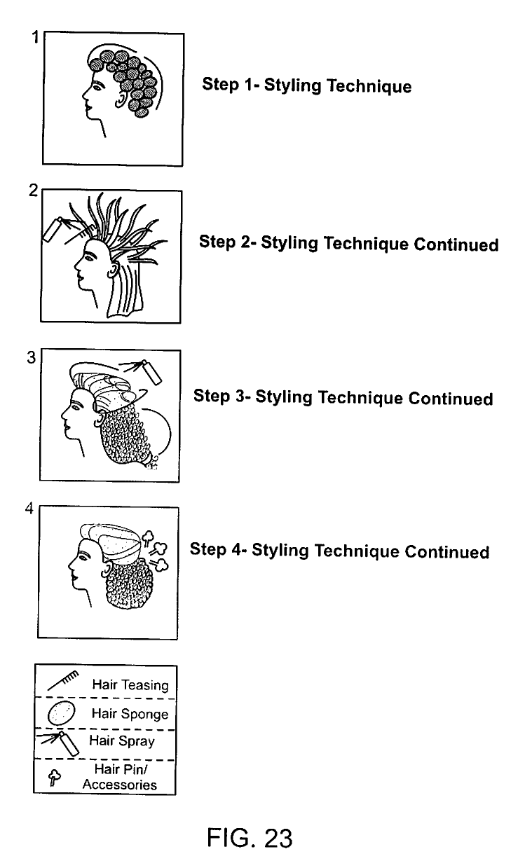

Hannah

| | |
|---|---|
| Pillar 1 | Body Shape and Head and Body Proportions |
| | Head and body balanced |
| Pillar 2 | Bone Structure/Head Divisions |
| | Almost perfect head shape |
| Pillar 3 | The Fabric of the Hair |
| | Hair Type: silk/medium hair |
| | Hair Character: 50 percent satin/straight; 50 percent wool/curly |
| Pillar 4 | Grade of Sensitivity |
| | Root S2; ends S3 |
| | Natural Hair Color: Light Brown |
| | Chemically Treated hair: yes. Full-head highlight, beige blonde. |
| Pillar 5 | Face Shape |
| | Oval face |
| | Composition of the Hair |
| | Healthy Scalp |
| | Cleanse/Treat/Protect |
| | Shampoo: Light moisturizing shampoo for color-treated hair |
| | Treatment: moisturizing conditioners; once a week heat treatment masque |
| | Protector for blow dryer: cream-based oil |
| | Protector for natural curl: curl enhancers; leave-in treatment |
| | Too: blow dryer; diffuser, iron, bore brush, thermal brush |
| Hair Style | FIG. 22 |
| | Step 1 - Styling Technique |
| | Use a curling iron to curl all the hair from the roots to the ends. Create a |
| | side part and do pin curls by going from the right to the left towards the |
| | ears to create a soft wave. Repeat the pin curls on the opposite side, going |
| | towards the ears. |
| | Step 2 - Styling Technique Continued |
| | In the back begin from the low nape zone and pin curl to the apex of the |
| | hair. |
| | Step 3 - Styling Technique Continued |
| | Open the pin curls starting from the low nape zone. Smooth out curls with |
| | a light serum to shape the curls, on the top comb the hair to the side and |
| | shape the curls toward the face to create a glamorous soft wavy. Tuck the |
| | left side of the hair behind the ear. |
| | Step 4 - Styling Technique Continued |
| | For an alternative look, clip on hair extensions that have already been pia |
| | curled. Add the hair extensions in the back area for more volume and |
| | length. Clip on one large piece on the occipital bone, and clip on another |
| | large piece 2 inchcs higher than the first one. Secure the left side by bobby |
| | pins and finish it with a hair accessory. Place a fishnet French veil on face |
| | to create a Hollywood glamour look. |

Kristy

| | |
|---|---|
| Pillar 1 | Body Shape and Head and Body Proportions |
| | Head proportionally smaller than the body. It was very important to match |
| | the head size to body so Kristy's body would look less full. Used three |
| | sponges on the top front and back areas of he hair to make the head shape |
| | larger to give her body a more balanced look |
| Pillar 2 | Bone Structure/Head Divisions |
| | Almost perfect head shape. Bone structure of the head is balanced but |
| | head is smaller than the body |
| Pillar 3 | The Fabric of the Hair |
| | Hair Type: silk/medium hair |
| | Hair Character: 50 percent satin/straight; 50 percent wool/curly |
| Pillar 4 | Grade of Sensitivity |
| | Root S2; ends S3 |
| | Natural Hair Color: Light Brown |
| | Chemically Treated hair: no. |
| Pillar 5 | Face Shape |
| | Oval face |
| | Composition of the Hair |
| | Healthy Scalp |
| | Cleanse/Treat/Protect |
| | Shampoo: volumizing shampoo |
| | Treatment: wheat protein plus cream masque; use shower cap and add heat |
| | Protector for blow dryer: cream-based oil |
| | Protector for natural curl: curl enhancers; leave-in treatment |
| | Too: bore brush, blow dryer, diffuser, curler, flat iron |
| Hair Style | FIG. 23 |
| | Step 1 - Styling Technique |
| | Use a large curling iron to curl all of the hair from the roots to the ends. |
| | Begin from the low zone. Go to curling the hair of the laterals. |
| | Step 2 - Styling Technique Continued |
| | Back comb the root area of the entire hair away from the face. |
| | Step 3 - Styling Technique Continued |
| | Place four sponges on the head. Secure the first one on the top and the |
| | second and third one on the back combed hair to enlarge the head. Softly |
| | comb the hair of the front out of the face while covering the three sponges |
| | with bobby pins at the occipital bone. Secure the forth sponge one on the |
| | nape area. Tie the bottom tip of the hair into a small pony tail. |
| | Step 4 - Styling Technique Continued |
| | Take the pony tail and fill upwards to cover the fourth sponge and secure it |
| | with bobby pins to a low Spanish bun. Spray the entire hair with a hair |
| | spray. Ask the client to stand up to see the final look at an eye level and do |
| | your finishing touches. |

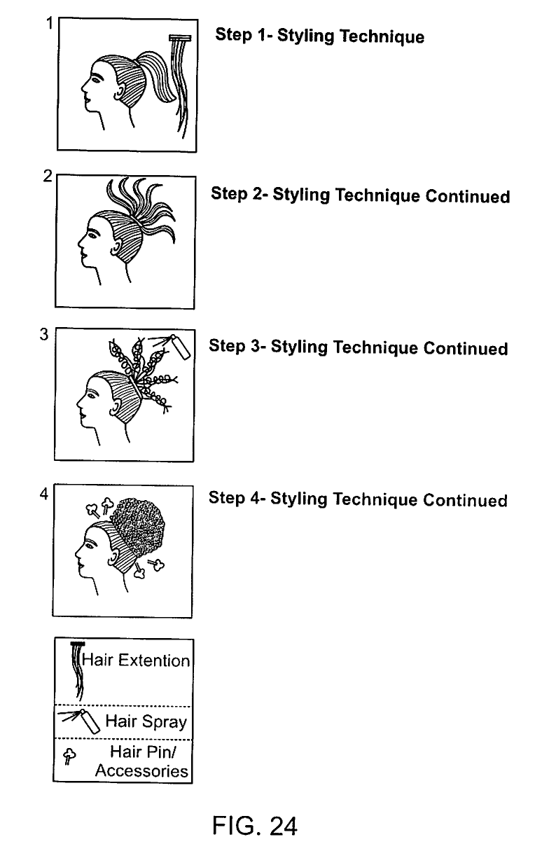

Gohar

| | |
|---|---|
| Pillar 1 | Body Shape and Head and Body Proportions |
| | Almost perfect body and head proportion |
| Pillar 2 | Bone Structure/Head Divisions |
| | Flat back and flat forehead. Almost all backbones are smaller and |
| | fringe/forehead area is smaller |
| Pillar 3 | The Fabric of the Hair |
| | Hair Type: silk/medium hair |
| | Hair Character: 50 percent satin/straight; 50 percent wool/curly |
| Pillar 4 | Grade of Sensitivity |
| | Root S2; ends S3 |
| | Natural Hair Color: Medium Brown |
| | Chemically Treated hair: yes. |
| | Target color process: medium chestnut brown on the entire hair to brighten |
| | her skin tone |
| Pillar 5 | Face Shape |
| | Oval face |
| | Composition of the Hair |
| | Healthy Scalp |
| | Cleanse/Treat/Protect |
| | Shampoo: light moisturizing shampoo for color treated hair |
| | Treatment: wheat protein plus cream masque; use shower cap and add heat |
| | Protector for blow dryer: cream-based oil |
| | Protector for natural curl: curl enhancers; leave-in treatment |
| | Too: bore brush. blow dryer, diffuser, curler, flat iron |
| Hair Style | FIG. 24 |
| | Step 1 - Styling Technique |
| | Prepare a high pony tail after blow drying with a round brush. Add a large |
| | amount of hair extension by large pins around the pony tail. |
| | Step 2 - Styling Technique Continued |
| | Divide the hair to one inch sections. Your goal is to interlace two sections |
| | together into chains of knots. |
| | Step 3 - Styling Technique Continued |
| | Interface two sections together into chains of knots to smooth the hair for |
| | easy styling, using styling cream or light hair spray. Secure the end of |
| | chain by pinning the end to the base. |
| | Step 4 - Styling Technique Continued |
| | According to the desired height and fullness, create about 20 chain knots, |
| | layering them on top of each other. At the end use hair accessories to |
| | distinguish look. |

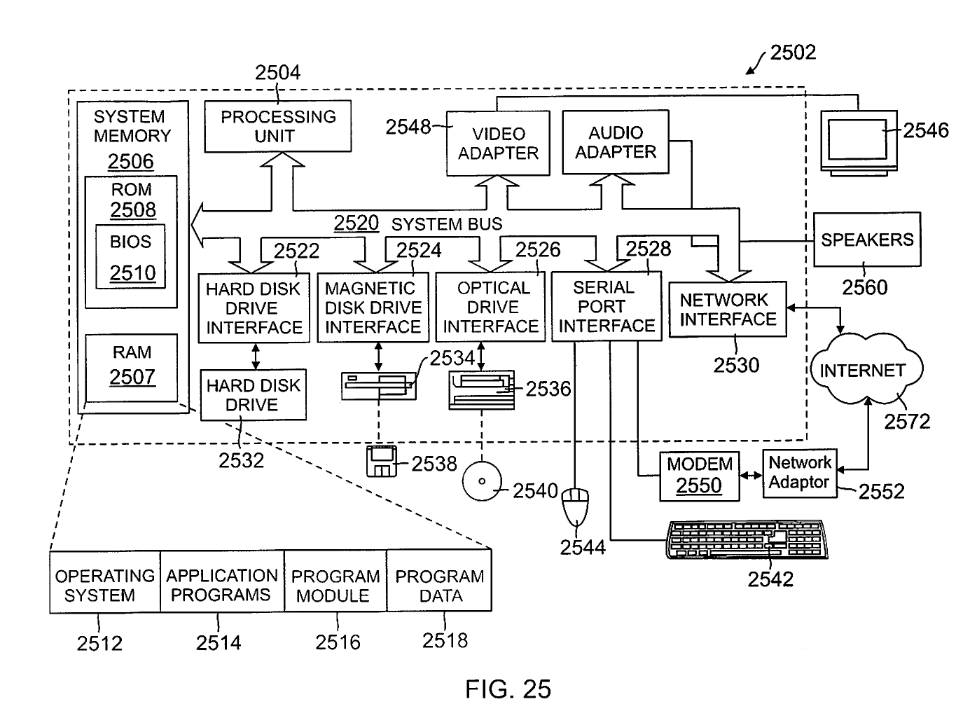

An exemplary hardware and operating environment for implementing the hair styling method 100 may include a computer 2502 as shown in FIG. 25. A stylist can input information from the five pillars and based on that information a hair style can be provided. The computer 2502 can include a processing unit 2504, a system memory 2506, and a system bus 2520 that operatively couples various system components, including the system memory 2506 to the processing unit 2504. There may be one or more processing units 2504. Such that the processor of computer 2502 comprises a single central processing unit (CPU), or a plurality of processor units, commonly referred to as a parallel processing environment. The computer 2502 may be a conventional computer, a distributed computer, a web server, a file service, or any other type of computer.

The system bus 2520 may be any of several types of bus structures including a memory bus or memory controller, a peripheral bus, a switched fabric, point-to-point connections, and a local bus using any of a variety of bus architectures. The system memory 2506 may also be referred to as simply the memory, and includes read only memory (ROM) 2508 and random access memory (RAM) 2507. A basic input/output system (BIOS) 2510, containing the basic routines that help to transfer information between elements within the computer 2502, such as during start-up, is stored in ROM 2508. The computer 2502 further includes a hard disk drive 2532 for reading from and writing to a hard disk, not shown, a magnetic disk drive 2534 for reading from or writing to a removable magnetic disk 2538, and an optical disk drive 2536 for reading from or writing to a removable optical disk 2540 such as a CD ROM or other optical media.

The hard disk drive 2532, magnetic disk drive 2534, and optical disk drive 2536 are connected to the system bus 2520 by a hard disk drive interface 2522, a magnetic disk drive interface 2524, and an optical disk drive interface 2526, respectively. The drives and their associated computer-readable media provide nonvolatile storage of computer-readable instructions; data structures, e.g., a catalog and a context-based index; program modules, e.g., a web service and an indexing robot; and other data for the computer 2502. It should be appreciated by those skilled in the art that any type of computer-readable media that can store data that is accessible by a computer, for example, magnetic cassettes, flash memory cards, digital video disks, RAM, and ROM, may be used in the exemplary operating environment.

A number of program modules may be stored on the hard disk 2532, magnetic disk 2534, optical disk 2536, ROM 2508, or RAM 2507, including an operating system 2512, one or more application programs 2514, other program modules 2516, and program data 2518. A user may enter commands and information into the personal computer 2502 through input devices such as a keyboard 2542 and pointing device 2544, for example, a mouse. Other input devices (not shown) may include, for example, a microphone, a joystick, a game pad, a tablet, a touch screen device, a satellite dish, a scanner, a facsimile machine, and a video camera. These and other input devices are often connected to the processing unit 2504 through a serial port interface 2528 that is coupled to the system bus 2520, but may be connected by other interfaces, such as a parallel port, game port or a universal serial bus (USB).

A monitor 2546 or other type of display device is also connected to the system bus 2520 via an interface, such as a video adapter 2548. In addition to the monitor 2546, computers typically include other peripheral output devices, such as a printer and speakers 2560. These and other output devices are often connected to the processing unit 2504 through the serial port interface 2528 that is coupled to the system bus 2520, but may be connected by other interfaces, such as a parallel port, game port, or a universal serial bus (USB).

The computer 2502 may operate in a networked environment using logical connections to one or more remote computers. These logical connections may be achieved by a communication device coupled to or integral with the computer 2502; the application is not limited to a particular type of communications device. The remote computer may be another computer a server, a router, a network personal computer, a client, a peer device, or other common network node, and typically includes many or all of the elements described above relative to the computer 2502, although only a memory storage device has been illustrated in FIG. 25. Computer 2502 can be logically connected to the internet 2572. The logical connection can include a local area network (LAN), wide area network (WAN), personal area network (PAN), campus area network (CAN), metropolitan area network (MAN), or global area network (GAN). Such networking environments are commonplace in office networks, enterprise-wide computer networks, internets and the Internet, which are all types of networks.

When used in a LAN environment, the computer 2502 may be connected to the local network through a network interface or adapter 2530, which is one type of communications device. When used in a WAN environment, the computer 2502 typically includes a modem 2550, a network adapter 2552, or any other type of communications device for establishing communications over the wide area network. The modem 2550, which may be internal or external, is connected to the system bus 2520 via the serial port interface 2528. In a networked environment, program modules depicted relative to the personal computer 2502, or portions thereof, may be stored in a remote memory storage device. It is appreciated that the network connections shown are exemplary and other means of and communications devices for establishing a communications link between the computers may be used.

The technology described herein may be implemented as logical operations and/or modules in one or more systems. The logical operations may be implemented as a sequence of processor-implemented steps executing in one or more computer systems and as interconnected machine or circuit modules within one or more computer systems. Likewise, the descriptions of various component modules may be provided in terms of operations executed or effected by the modules. The resulting implementation is a matter of choice, dependent on the performance requirements of the underlying system implementing the described technology. Accordingly, the logical operations making up the embodiments of the technology described herein arc referred to variously as operations, steps, objects, or modules. Furthermore, it should be understood that logical operations may be performed in any order, unless explicitly claimed otherwise or a specific order is inherently necessitated by the claim language.

The embodiments presented herein of the system and method are preferably computer programs run on a computer system. One skilled in the relevant art will appreciate that the computer system can include code that is loaded from a hard drive to be run on the processor. Alternatively, the system can be saved on a suitable storage medium such as a diskette, a CD, or like devices.

The system can take the form of an entirely hardware embodiment, an entirely software embodiment or an embodiment containing both hardware and software elements. In one embodiment, the system is implemented in software, which includes but is not limited to firmware, resident software, microcode, etc.

Furthermore, the system can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium comprise a semiconductor or solid-state memory, magnetic tape, a removable computer diskette, a random access memory (RAM), a read-only memory (ROM), a rigid magnetic disk and an optical disk. Current examples of optical disks comprise compact disk-read only memory (CD-ROM), compact disk-read/write (CD-R/W) and DVD.

A data processing system suitable for storing and/or executing program code comprises at least one processor coupled directly or indirectly to memory elements through a system bus. The memory elements can include local memory employed during actual execution of the program code, bulk storage, and cache memories that provide temporary storage of at least some program code in order to reduce the number of times code is retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

Described above, aspects of the present application are embodied in a World Wide Web (“WWW”) or (“Web”) site accessible via the Internet. As is well known to those skilled in the art, the term “Internet” refers to the collection of networks and routers that use the Transmission Control Protocol/Internet Protocol (“TCP/IP”) to communicate with one another. The internet can include a plurality of local area networks (“LANs”) and a wide area network (“WAN”) that are interconnected by routers. The routers are special purpose computers used to interface one LAN or WAN to another. Communication links within the LANs may be wireless, twisted wire pair, coaxial cable, or optical fiber, while communication links between networks may utilize 56 Kbps analog telephone lines, 1 Mbps digital T-1 lines, 45 Mbps T-3 lines or other communications links known to those skilled in the art.

Furthermore, computers and other related electronic devices can be remotely connected to either the LANs or the WAN via a digital communications device, modem and temporary telephone, or a wireless link. It will be appreciated that the internet comprises a vast number of such interconnected networks, computers, and routers.

The Internet has recently seen explosive growth by virtue of its ability to link computers located throughout the world. As the Internet has grown, so has the WWW. As is appreciated by those skilled in the art, the WWW is a vast collection of interconnected or “hypertext” documents written in HTML, or other markup languages, that are electronically stored at or dynamically generated by “WWW sites” or “Web sites” throughout the Internet. Additionally, client-side software programs that communicate over the Web using the TCP/IP protocol are part of the WWW, such as web browsers, SOAP clients. JavaScript Java Applets, instant messaging, e-mail, browser plug-ins, Macromedia Flash, chat and others. Other interactive hypertext environments may include proprietary environments such as those provided in America Online or other online service providers, as well as the “wireless Web” provided by various wireless networking providers, especially those in the cellular phone industry. It will be appreciated that the present application could apply in any such interactive communication environments, however, for purposes of discussion, the Web is used as an exemplary interactive hypertext environment with regard to the present application.

A website is a server/computer connected to the Internet that has storage capabilities for storing hypertext documents and that runs administrative software for handling requests for those stored hypertext documents as well as dynamically generating hypertext documents. Embedded within a hypertext document are a number of hyperlinks, i.e., highlighted portions of text which link the document to another hypertext document possibly stored at a website elsewhere on the Internet. Each hyperlink is assigned a URL that provides the name of the linked document on a server connected to the Internet. Thus, whenever a hypertext document is retrieved from any web server, the document is considered retrieved from the World Wide Web. Known to those skilled in the art, a web server may also include facilities for storing and transmitting application programs, such as application programs written in the JAVA.RTM. programming language from Sun Microsystems, for execution oil a remote computer. Likewise, a web server may also include facilities for executing scripts and other application programs on the web server itself.

A remote access user may retrieve hypertext documents from the World Wide Web via a web browser program. A web browser, such as Mozilla Firefox or Microsoft's Internet Explorer, is a software application program for providing a user interface to the WWW. Upon request from the remote access user via the web browser, the web browser requests the desired hypertext document from the appropriate web server using the URL for the document and the hypertext transport protocol (“HTTP”). HTTP is a higher-level protocol than TCP/IP and is designed specifically for the requirements of the WWW. HTTP runs on top of TCP/IP to transfer hypertext documents and user-supplied form data between server and client computers. The WWW browser may also retrieve programs from the web server, such as JavaScript or JAVA applets, for execution on the client computer. Finally, the WWW browser may include optional software components, called plug-ins, that run specialized functionality within the browser.

In accordance with one aspect of the present application, a system for applying treatments to an individual is presented. The system includes a database storing cut, color, style, treatment, protection, and tools information. In addition, the system includes at least one processor and a memory operatively coupled to the processor, the memory storing program instructions. When executed by the processor, the instructions cause the processor to receive information about a head and body proportions of the individual, receive information about a bone structure of a head of the individual, receive information about a fabric of hair of the individual, receive information about a grade of sensitivity of the individual, and receive information about a face shape of the individual. Based on the fabric of hair and grade of sensitivity, the instructions when executed by the processor causes the processor to select and display a prescribed treatment, protection and tools from the database that can be used on the individuals hair. Based on the head and body proportions, bone structure of head, and face shape of the individual, the instructions when executed by the processor causes the processor to select and display a cut, color and style from the database that is most appropriate for the individual's hair.

In accordance with another aspect, the database further stores makeup information and the memory storing program instructions that when executed by the processor, further causes the processor to select and display a makeup from the database that can be applied to the individual. In accordance with yet another aspect, the database further stores dress information and the memory storing program instructions that when executed by the processor, further causes the processor to select and display a dress from the database that can be applied to the individual.

In accordance with another aspect, wherein selecting and displaying the hairstyle from the database based on the body shape includes allowing the individual to choose their hairstyle when the body shape is proportional to the head of the individual. In accordance with yet another aspect, wherein selecting and displaying the hairstyle from the database based on the body shape includes minimizing the individual's hairstyle when the individual's head is proportionally larger than the body. In accordance with another aspect, wherein selecting and displaying the hairstyle from the database based on the body shape includes emphasizing the individual's hairstyle when the individual's head is proportionally smaller than the body.

In accordance with another aspect, wherein selecting and displaying the hairstyle from the database based on the head and body proportions has seven inquires including determining information about the individual's ears, humps on neck, length of neck, width of shoulders, bust line, height, and weight. In accordance with yet another aspect, wherein selecting and displaying the hairstyle from the database based on the bone structure of the head of the individual includes locating the smallest and larges bones.

In accordance with another aspect, wherein selecting and displaying the hairstyle from the database based on the face shape of the individual includes creating an illusion that the individual has an oval face shape. In accordance with still yet another aspect, wherein selecting and displaying the prescribed treatment, protection and tools from the database based on the fabric of hair includes choosing a cream base oil for wool and denim fabrics of hair. In accordance with another aspect, wherein selecting and displaying the prescribed treatment, protection and tools from the database based on the grade of sensitivity has five grades including S1, S2, S3, S4, and S5.

In accordance with another aspect of the present application, a method for beautifying hair is presented. The method includes in a first pillar, evaluating an individual's head and body proportions. In addition, the method includes in a second pillar, evaluating the individual's bone structure and in a third pillar, evaluating the individual's fabric of hair. Furthermore, the method includes in a fourth pillar, evaluating the individual s grade of sensitivity, and in a fifth pillar, evaluating the individual's face shape. From the pillars, the method includes applying a beautification treatment.

In accordance with another aspect of the present application, the method of further including selecting a makeup based on the first, second, and fifth pillar. In accordance with yet another aspect, the method including selecting a dress based on the first, second, and fifth pillar. In accordance with still yet another aspect, wherein the head and body proportions includes determining proportions between the individuals head and ears.

In accordance with another aspect, the method includes placing a hand on a bang/fringe area, sliding the hand to a top front portion of the head, sliding the hand to a back portion of the head, and sliding the hand to the occipital bone. In accordance with yet another aspect, the method includes placing both hands on the top front portion, sliding a first hand from a top front to a right front, and sliding a second hand from a top front side to a left front side before the ears. In accordance with another aspect, the method includes sliding the first hand from the top front to right back side, and sliding the second hand from the top front to the left back side in back of ears.

In accordance with another aspect, the method includes touching the hair from its root to its ends. In accordance with yet another aspect, the method includes generalizing the shape to either an oval, round, square, diamond, heart, pear, or oblong shape.

In accordance with yet another aspect of the present application, a process for cutting, coloring and styling an individual's hair is presented. The process includes generalizing the individual's hair to a fabric and grade of sensitivity to select a prescribed treatment, protection and tools to be used on the individual's hair. In addition, the process includes generalizing the individual's head and body proportions, bone structure of head, and face shape to select a hairstyle that can be applied to the individual's hair.

In accordance with another aspect, the process includes generalizing the individual's fabric as chiffon, silk, or denim. In accordance with yet another aspect, the process includes generalizing the individual's grade of sensitivity as S2, S2, S3, S4, or S5.

The foregoing description is provided to enable any person skilled in the relevant art to practice the various embodiments described herein. Various modifications to these embodiments will be readily apparent to those skilled in the relevant art, and generic principles defined herein may be applied to other embodiments. Thus, the claims are not intended to be limited to the embodiments shown and described herein, but are to be accorded the full scope consistent with the language of the claims, wherein reference to an element in the singular is not intended to mean “one and only one” unless specifically stated, but rather “one or more.” All structural and functional equivalents to the elements of the various embodiments described throughout this disclosure that are known or later come to be known to those of ordinary skill in the art are expressly incorporated herein by reference and intended to be encompassed by the claims. Moreover, nothing disclosed herein is intended to be dedicated to the public regardless of whether such disclosure is explicitly recited in the claims.

What is claimed is:

1. A system for applying treatments to an individual, the system comprising:
a database storing cut, color, style, treatment, protection, and tools information;
at least one processor;
a memory operatively coupled to the processor, the memory storing program instructions that when executed by the processor, causes the processor to:
receive information about a body shape and head and body proportions of the individual;
receive information about a bone structure of a head of the individual;
receive information about a fabric of hair of the individual;
receive information about a grade of sensitivity of the individual:
receive information about a face shape of the individual;
based on the fabric of hair and grade of sensitivity, select and display a prescribed treatment, protection and tools from the database that can be used on the individual's hair; and
based on the body shape and head and body proportions, bone structure of head, and face shape, select and display a cut, color and style from the database that can be applied to the individual's hair.

2. The system of claim 1, wherein the database further stores makeup information and the memory storing program instructions that when executed by the processor, further causes the processor to select and display a makeup from the database that can be applied to the individual.

3. The system of claim 1, wherein the database further stores dress information and the memory storing program instructions that when executed by the processor, further causes the processor to select and display a dress from the database that can be applied to the individual.

4. The system of claim 1, wherein selecting and displaying the hairstyle from the database based on the body shape comprises allowing the individual to choose their hairstyle when the body shape is proportional to the head of the individual.

5. The system of claim 1, wherein selecting and displaying the hairstyle from the database based on the body shape comprises minimizing the individual's hairstyle when the individuals head is proportionally larger than the body.

6. The system of claim 1, wherein selecting and displaying the hairstyle from the database based on the body shape comprises emphasizing the individual's hairstyle when the individual's head is proportionally smaller than the body.

7. The system of claim 1, wherein selecting and displaying the hairstyle from the database based on the head and body proportions comprises seven inquires including determining information about the individual's ears, humps on neck, length of neck, width of shoulders, bust line, height and weight.

8. The system of claim 1, wherein selecting and displaying the hairstyle from the database based on the bone structure of the head of the individual comprises locating the smallest and larges bones.

9. The system of claim 1, wherein selecting and displaying the hairstyle from the database based on the face shape of the individual comprises creating an illusion that the individual has an oval face shape.

10. The system of claim 1, wherein selecting and displaying the prescribed treatment, protection and tools from the database based on the fabric of hair comprises choosing a cream base oil for wool and denim fabrics of hair.

11. The system of claim 1, wherein selecting and displaying the prescribed treatment, protection and tools from the database based on the grade of sensitivity comprises five grades including S1, S2, S3, S4, and S5.

12. A method for beautifying an individual comprising:
in a first pillar, evaluating an individual's body shape and head and body proportions;
in a second pillar, evaluating the individual's bone structure;
in a third pillar, evaluating the individual's fabric of hair;
in a fourth pillar, evaluating the individual's grade of sensitivity;
in a fifth pillar, evaluating the individual's face shape;
from the pillars, applying a beautification treatment.

13. The method of claim 12, further comprising selecting a makeup based on the first, second, and fifth pillar.

14. The method of claim 12, further comprising selecting a dress based on the first, second, and fifth pillar.

15. The method of claim 12, wherein the head and body proportions includes determining proportions between the individual's head and ears.

16. The method of claim 12, wherein evaluating the individual's bone structure comprises:
placing a hand on a bang/fringe area;
sliding the hand to a top front portion of the head;
sliding the hand to a back portion of the head; and
sliding the hand to the occipital bone.

17. The method of claim 16, wherein evaluating the individual's bone structure further comprises:
placing both hands on the top front portion;
sliding a first hand from a top front to a right front; and
sliding a second hand from a top front side to a left front side before the ears.

18. The method of claim 17, wherein evaluating the individual's bone structure further comprises:
sliding the first hand from the top front to right back side; and
sliding the second hand from the top front to the left back side in back of ears.

19. The method of claim 12, wherein evaluating the individual's fabric of hair comprises touching the hair from its root to its ends.

20. The method of claim 12, wherein evaluating the individual's face shape comprises generalizing the shape to either an oval, round, square, diamond, heart, pear, or oblong shape.

21. A process for cutting, coloring and styling an individual's hair comprising:
generalizing the individual's hair to a fabric and grade of sensitivity to select a prescribed treatment, protection and tools to be used on the individual's hair; and
generalizing the individual's body shape and head and body proportions, bone structure of head, and face shape to select a cut, color and style that can be applied to the individual's hair.

22. The process of claim 21, wherein the individual's fabric can be generalized as chiffon, silk, or denim.

23. The process of claim 21, wherein the individual's grade of sensitivity can be generalized as S2, S2, S3, S4, or S5.
